(19) United States
(12) Patent Application Publication
(10) Pub. No.: US 2016/0376440 A1
(43) Pub. Date: Dec. 29, 2016

(54) ASPHALT ADDITIVE, ASPHALT COMPOSITIONS AND PRODUCTS COMPRISING SUCH ADDITIVE, ASPHALT SURFACES COMPRISING SUCH ADDITIVE, METHODS OF MAKING AND USING SUCH ADDITIVE, COMPOSITIONS, SURFACES AND PRODUCTS

(71) Applicant: GREEN PAVING SOLUTIONS, LLC, Pass Christian, MS (US)

(72) Inventors: PREMNATHAN NAIDOO, Diamondhead, MS (US); Terry Naidoo, Diamondhead, MS (US); Trey Bowen, Kansas City, MO (US); Grant Wollenhaupt, Leawood, KS (US); Jennifer Breuer, Lathrop, MO (US)

(73) Assignee: GREEN PAVING SOLUTIONS, LLC, Pass Christian, MS (US)

(21) Appl. No.: 14/752,824

(22) Filed: Jun. 26, 2015

(51) Int. Cl. C08L 95/00; C08K 11/00; C08K 5/54; C08J 9/12; C08K 5/17

(52) U.S. Cl. CPC C08L 95/00; C08J 9/125; C08K 5/17; C08K 5/54; C08K 11/00; C08J 2395/00; C08J 2203/10

(57) ABSTRACT

An asphalt additive comprising an oil component comprising vegetable oil and/or a crude tall oil, an amine component, and an organosilane component. Asphalt compositions and products comprise asphalt binder, aggregate, and the additive. Treatment methods include contacting asphalt compositions or asphalt products with the additive.

### RELATED APPLICATION DATA

Not applicable.

### BACKGROUND OF THE INVENTION

1. Field of the Invention

The present invention relates to asphalt additives, to asphalt compositions, asphalt surfaces and asphalt products made from such asphalt additives, to asphalt compositions, products and surfaces comprising such additives, and to methods of making and using such additives, compositions, surfaces and products In another aspect, the present invention relates to asphalt additives comprising an oil component, an amine component and an organosilane component, to asphalt compositions, products and surfaces made from or with such additives, to methods of making and using such additives, compositions, surfaces, and products. In even another aspect, the present invention relates to asphalt additives comprising a vegetable oil component, an amine component and an organosilane component, to asphalt compositions, products and surfaces made from such additives, to methods of making and using such additives, compositions, surfaces, and products. In still another aspect, the present invention relates to asphalt additives comprising an oil component of vegetable oil and/or crude tall oil, an amine component and an organosilane component, to asphalt compositions, products and surfaces made from or with such additives, to methods of making and using such additives, compositions, surfaces, and products. In yet another aspect, the present invention relates to asphalt additives comprising an oil component of vegetable oil and/or crude tall oil, an amine component and an organosilane component, to asphalt compositions, products and surfaces made from or with such additives, to asphalt compositions, products and surfaces made from such additives which also include recycled asphalt material, to asphalt compositions, products and surfaces made from such additives which also include rejuvenated asphalt material, to methods of making and using such additives, compositions, surfaces, and products. In even still another aspect, the present invention relates to adhesive agents for asphalt binders comprising organosilane and amine, to asphalt products comprising asphalt binder, organosilane and amine, and to methods of making such adhesive agents and products.

2. Description of the Related Art

Paving roadways, driveways, parking lots, and the like with a bituminous aggregate mixture material is well known. Typically, a mixture of a suitable aggregate comprising stones, gravel, sand, and the like, is heated at an elevated temperature of about 270-370° F. and mixed with a similarly hot, bituminous binder such as an asphalt-based binder (e.g., asphalt or asphalt plus polymer and additives) until the aggregate particles are coated with the binder. Paving mixes made in this temperature range are often referred to as a hot mix. The mixing typically occurs away from the paving site, and the mixture is then hauled to the site and supplied to a paving machine. The mixture of asphalt and aggregate applied by the paving machine to a surface is then usually roller compacted by additional equipment while still at an elevated temperature. The compacted aggregate and asphalt material eventually hardens upon cooling. Because of the large mass of material in paving a roadway or commercial parking lot, the cost of the thermal energy to achieve suitable mixing and paving is considerable. For common binders, the thermoviscosity characteristics of the binder affect the temperature needed to provide thorough coating of the aggregate and consideration of the ambient conditions suitable for paving. Consequently, numerous processes have been devised to optimize aggregate coating and pavement binding while minimizing the cost of materials and/or the process.

As alternatives to hot-mix processes, there are cold-mix processes, where the aggregate, cold and moist, is mixed with a hot or cold binder, which can be an emulsion of asphalt dispersed in water using a suitable surfactant or a mixture of asphalt and a suitable hydrocarbon solvent, such as naphtha, #1 oil, or #2 oil, to name a few (generally referred to as a cutback asphalt). The emulsified asphalt particles coat and bind with the aggregate and remain after the water has evaporated. When a cutback asphalt is used, the hydrocarbon solvent evaporates at different rates depending on the volatility of the solvent. Regardless of the solvent volatility, what remains behind is a paving material where the asphalt component gradually hardens or stiffens over time as the solvent is removed. The binder can alternatively be foamed and mixed with the aggregate to enhance the coating efficacy. While less expensive than hot mixes, cold mixes usually are poorer quality than the hot mixes, and may have poorer binder coating, resulting in less cohesive compaction and durability. Additionally, cutback asphalt mixes have greater environmental impact due to the use of volatile hydrocarbon solvents. Some emulsions also utilize hydrocarbon solvents in addition to water to produce materials suitable for specific applications.

In an attempt to combine the advantages of hot-mix and cold-mix processes, warm-mix processes have been developed. In one example of a warm-mix process, both “soft” (a component with a lower viscosity than a “hard” component at a given temperature) and “hard” (a component with a higher viscosity than a “soft,” component at a given temperature) components of a bituminous binder are used. The soft component is melted and mixed with aggregate at about 110-265° F., depending on the particular soft component. The heated hard component is then mixed with warm water so as to produce a foam which is mixed with the heated soft component/aggregate mix to achieve a final, coated, paving material. Although a warm-mix paving material can be paved at lower temperatures than hot-mix materials, it requires a more extensive and complex process to produce the warm mix compared to a hot mix (For example the Shell WAM process).

Finally, Half-Warm mix is an asphalt min that is mixed and paved at the temperature window of 140 F to 212 F.

Asphalt pavements deteriorate over time due to the impact of traffic, water and sunlight. The deterioration in pavement quality can lead to permanent deformation or rutting, cracking or brittleness and can lead to binder stripping and inferior skid resistance. The deterioration is evident from a decrease in penetration value (for example measured at 25° C. in accordance with EN 1426 or ASTM D5-97) and an increase in softening point (for example measured using the Ring and Ball technique in accordance with EN 1427 or ASTM D36-95). More recent testing demonstrates the deterioration through Performance Grade testing on asphalt mixes taken from commercial pavements where m-value and creep stiffness are negatively impacted (measured using testing equipment in accordance with AASHTO M320).

Modern recycling techniques offer a means of recovering desirable pavement properties without replacing the entire pavement with new materials. Additionally they enable reuse of production waste from the asphalt pavement industry. Recycling asphalt pavements has the advantages of decreasing the demand for natural resources, decreasing the production of waste material and reducing costs. Desirably the amount of the asphalt pavement that is recycled is maximized and the amount of new material that is added to the recovered asphalt is minimized.

Reclaimed asphalt pavement (known as RAP) can be recycled “in-place” (i.e. at the road location), or can be recycled “in-plant” (i.e. the RAP is removed from the road surface and transported to an asphalt mix plant). In a hot in-place recycling process, the existing pavement is reheated and milled and virgin aggregate and preferably a rejuvenating agent is added to the RAP. This process is primarily used for resurfacing the top layer of a pavement and can re-use up to 100% of the RAP. In a hot in-plant recycling process, the RAP is broken, milled, and fractionated, and virgin aggregate, and preferably a rejuvenating agent and, in some instances, fresh bitumen are added. The in-plant process may be used for the construction of new base layers, but it can be difficult to incorporate a high level of RAP into the final product at the date of the invention due to constraints of the asphalt mix plant, and typically the final product consists of up to about 50% RAP, but more commonly 25-35% RAP.

The function of the rejuvenating agent (also known as a recycling agent) is to modify the properties of the aged binder contained in the RAP so that the recycled asphalt has properties resembling those of the original asphalt. It may not be possible to restore the asphalt to its former state, but it should be possible to significantly improve those properties that have been subject to deterioration.

The following patents and publications relate to asphalt and/or rejuvenation of asphalt.

U.S. Pat. No. 4,375,988, issued Mar. 8, 1983, discloses bituminous binders which contain at least one silane and show excellent improvement of adhesion. The bituminous binder containing silane is manufactured by heating The bituminous binder to a temperature of 120°-230° C. and stifling in the silane. All known silanes can be used as the silane. The resulting compositions can be used for the production of street surfacings, industrial floors, floorings, building protective paints, roof coating masses, undercoatings for motor vehicles and rail vehicles, and cable covering compounds.

U.S. Pat. No. 6,186,700, issued Feb. 13, 2001, to Omann, discloses a method of manufacturing and applying a novel pavement and patch material for roadways, driveways, walkways, patch for potholes and like surfaces, including the steps of reducing recycled asphalt roof waste to granules, adding aggregate and other solid recyclable materials to the granules, adding rejuvenating oil, adding emulsifier, adding asphalt concrete oil, adding anti-strip additives, adding liquid silicone, mixing the composition, heating the composition, applying the composition to the roadway or the like and compacting a new paving material.

US Patent Application Publication No. 2007/0191514, published Aug. 16, 2007, discloses a bituminous composition, a process for preparing a bituminous paving composition and process for bituminous paving having lower mixing, paving, and compaction temperatures than for conventional hot-mix paving while retaining sufficient performance characteristics of conventional hot-mix paving. The inventive paving process comprises the steps of injecting a heated foamable solution comprising a lubricating substance into a heated, asphalt binder to provide a heated, foamed mixture; adding the heated, foamed mixture to a suitable, heated aggregate; further mixing the heated, foamed mixture and heated aggregate to coat the heated aggregate with the heated, foamed, asphalt binder to form a heated paving material; supplying the heated paving material to a paving machine; applying the heated paving material by the paving machine to a surface to be paved; and compacting the applied paving material to form a paved surface.

CA Patent Application Publication No. 2698734, published Mar. 12, 2009, discloses a warm mix asphalt binder compositions containing lubricating additives, namely, a functionally dry warm mix asphalt binder composition modified with lubricating additives that can be mixed with aggregate and compacted at temperatures substantially below asphalt binder compositions that do not contain the disclosed lubricating additives.

U.S. Pat. No. 7,811,372, issued Oct. 12, 2010, discloses a rejuvenating agent and process for recycling of asphalt, the rejuvenating agent having a viscosity of from 200 to 60000 cSt at 60° C. and comprising 10-90 weight % palm oil and 90-10 weight % bitumen, where the percentages are based upon the total weight of the composition, is disclosed. The rejuvenating agent is suitable for use in hot in-place and hot in-plant recycling processes.

EP Patent Application Publication No. 2476657, published Jul. 18, 2012, discloses a temperature-adjusted and modified recycled ascon composition for reusing 100% of waste ascon for road pavement, and method for manufacturing same. The publication provides compositions and manufacturing methods of a modified, Reclaimed Asphalt Pavement (“RAP”)-recycled, temperature-controlled, asphalt mix. In detail, the 100 parts by weight of RAP having all gradations with particle sizes less than 53 mm enters into the inlet of virgin aggregates in a mixer, and then after the 0.1-20 parts by weight of a recycling modifier and the 0.1-20 parts by weight of a temperature-controlling agent are added into the same mixer from the position of the virgin asphalt binder sprayer, these are mixed together to make a uniform mix for 0.5-3 minutes at a mixing temperature of 5-180° C. The resulting mix is noted to be useful as a wearing course, a surface layer, an intermediate layer and a base layer of asphalt pavements. A recycling modifier is utilized to improve the physical properties, and a temperature-controlled agent takes a function of controlling production and construction temperatures for the RAP-recycled mix. Since this invention uses exclusively RAP aggregates without using virgin aggregates, the following benefits are alleged: savings of original material cost and waste disposal fee, prevention of destructing natures due to acquirement of aggregates, savings of virgin asphalt binders and aggregates, prevention of environmental pollution due to consumption of the RAP waste, prevention of early pavement rutting and fatigue cracking due to quality improvement achieved by a recycling modifier, economic gains of extending pavement life, usage of a surface course and a surface layer of recycled pavements for major roads, energy savings in production and less evolvement of greenhouse gases by using a temperature-controlling agent, etc. The invention is alleged to contribute to enhancing the RAP-recycling technology broadly and create economic, social, and technological benefits.

WO Patent Application Publication No. 2013053882, published Apr. 18, 2013, discloses an additive for asphalt mixes containing reclaimed bituminous products. A method of improving the incorporation of recycled bituminous products is accomplished by using at least one surfactant as an alternative to the known rejuvenating oils, for the preparation of asphalt mixes containing recycled bituminous products. The use of such alternative surfactant(s) results in better mechanical properties of the asphalt mix, while using smaller amounts of fresh bitumen and greater amounts of recycled bituminous products.

WO Patent Application Publication No. 2013090283, published Jun. 20, 2013, discloses the rejuvenation of reclaimed asphalt. The disclosed asphalt compositions comprise reclaimed asphalt and an ester-functional rejuvenating agent. Rejuvenated binder compositions are also included. The rejuvenating agents restore to reclaimed asphalt the more desirable properties of virgin asphalt. Reduced glass-transition onset temperatures and improved creep stiffness in the rejuvenated binders translate to improved low-temperature cracking resistance in the asphalt. The rejuvenating agents impart desirable softening at low dosage while also maintaining acceptable penetration values. Dynamic shear rheometry results demonstrate that criteria for asphalt compositions under low, intermediate, and high temperature conditions can be achieved, and the asphalt will have good fatigue cracking resistance and rutting avoidance. The rejuvenating agents reduce the temperature needed to compact or mix asphalt compositions, which conserves energy and reduces cost. The rejuvenated asphalt and binder compositions will enable greater use of reclaimed asphalt, especially RAP, and help the road construction industry reduce its reliance on virgin, non-renewable materials.

US Patent Application Publication No. 20130276668, published Oct. 24, 2013, discloses foamed asphalt compositions including quaternary organosilanes, and processes for the preparation of asphalt compositions including a step of adding an organosilane composition, including one or more quaternary organosilane compounds, to an asphalt binder to provide a stable foamed asphalt binder composition. The foamed asphalt binder composition can be mixed with, sprayed onto, or otherwise coated substantially over the outer surface on an aggregate to provide an asphalt composition suitable for a variety of paving applications.

U.S. Pat. No. 8,608,845, issued Dec. 17, 2013, to Naidoo et al, discloses cutback asphalt compositions and products comprising an extender derived from tall oil, and methods for making and using same, wherein the cutting solvent comprises a tall oil based solvent and optionally other renewable solvents.

US Patent Application Publication No. 20140286705, published Sep. 25, 2014, discloses Warm mix asphalt binder compositions containing lubricating additives, namely, a functionally dry warm mix asphalt binder composition modified with lubricating agents or additives that can be mixed with aggregate and compacted at temperatures substantially below asphalt binder compositions that do not contain the disclosed lubricating additives.

PRNewswire, Jun. 4, 2015, The Warner Babcock Institute for Green Chemistry, LLC (WBI) and Collaborative Aggregates, LLC announce the commercial availability of Delta S™ additive, an easy-to-use liquid additive that reverses aging and oxidation in reclaimed asphalt for exceptional performance and longevity. Delta S also performs as a warm mix asphalt (WMA) additive, significantly reducing paving temperatures and minimizing energy consumption. 100% worker safe and environmentally friendly, Delta S can be used in any traditional hot mix, recycling, in-place recycling or warm mix asphalt application. Renewably sourced, this plant based solution reduces paving costs by increasing the amount of reclaimed asphalt that can be effectively used while reducing paving temperatures needed for optimal performance. Features include single tank storage for dual purpose WMA and recycled asphalt rejuvenator; can be added during any phase of production; non-toxic, worker safe and environmentally friendly; enables the use of higher ratio RAP and RAS to virgin asphalt and aggregate without affecting pavement performance; third-party test data shows comparable performance to virgin asphalt; and significantly lowers paving temperatures, reducing energy usage and extending paving season.

Finally, various fractions isolated from crude tall oil (CTO) distillation have been used in asphalt compositions, although they are not specifically taught for rejuvenation. See, for instance, US Patent Application Publication No. 2010/0170417 (CTO distillation fractions as cutting solvents use in asphalt compositions); US Patent Application Publication No. 2010/0147190 (distilled or oxidized tall oil components for use in asphalt compositions); and U.S. Pat. Nos. 4,479,827 and 4,373,960 (patching compositions comprising asphalt, tall oil, and possibly an organopolysiloxane).

To date, the industry has combined a Warm-Mix Additive with an Adhesion Promoter or Warm-Mix Additive with a Rejuvenator.

Thus, in spite of the advances in the asphalt art, there is still a need in the art for asphalt additives, for asphalt compositions, asphalt surfaces and asphalt products made from such asphalt additives, for asphalt compositions, products and surfaces comprising such additives, and for methods of making and using such additives, compositions, surfaces and products.

There is another need in the art for asphalt additives comprising an oil component, an amine component and an organosilane component, for asphalt compositions, products and surfaces made from or with such additives, and for methods of making and using such additives, compositions, surfaces, and products.

There is even another need in the art for asphalt additives comprising a vegetable oil component, an amine component and an organosilane component, for asphalt compositions, products and surfaces made from such additives, and for methods of making and using such additives, compositions, surfaces, and products.

There is still another need in the art for asphalt additives comprising an oil component of vegetable oil and/or crude tall oil, an amine component and an organosilane component, for asphalt compositions, products and surfaces made from or with such additives, and for methods of making and using such additives, compositions, surfaces, and products.

There is yet another need in the art for asphalt additives comprising an oil component of vegetable oil and/or crude tall oil, an amine component and an organosilane component, for asphalt compositions, products and surfaces made from or with such additives, for asphalt compositions, products and surfaces made from such additives which also include recycled asphalt material, for asphalt compositions, products and surfaces made from such additives which also include rejuvenated asphalt material, and for methods of making and using such additives, compositions, surfaces, and products.

There is even still another need in the art for a compatible additive package that will reduce the number of additives the customer will need to keep in inventory at the terminal or mixing plant.

There is even yet another need in the art for a compatible additive package that will eliminate the need for multiple injection or dosing points at the plant for multiple additives.

There is still even another need in the art for a compatible additive package that will provide flexibility to the contractor to use different aggregates sources or higher RAP or RAS contents that were previously restrictive and difficult to use during plant production.

There is still yet another need in the art for a compatible additive package that facilitate production and laydown of asphalt mixture at hot-mix, warm-mix, and cold-mix temperatures while achieving compaction.

There is yet even another need in the art for a compatible additive package that will be cost competitive as a multi-purpose tool to be used by asphalt contractors and asphalt terminals in the industry.

These and other needs in the art will become apparent to those of skill in the art upon review of this specification, including its drawings and claims.

### SUMMARY OF THE INVENTION

It is an object of the present invention to provide for improved asphalt compositions, improved asphalt products, and methods of making and using such compositions and products to make pavement compositions composed of such compositions.

It is another object of the present invention to provide for asphalt additives, for asphalt compositions, asphalt surfaces and asphalt products made from such asphalt additives, for asphalt compositions, products and surfaces comprising such additives, and for methods of making and using such additives, compositions, surfaces and products.

It is even another object of the present invention to provide for asphalt additives comprising an oil component, an amine component and an organosilane component, for asphalt compositions, products and surfaces made from or with such additives, and for methods of making and using such additives, compositions, surfaces, and products.

It is still another object of the present invention to provide for asphalt additives comprising a vegetable oil component, an amine component and an organosilane component, for asphalt compositions, products and surfaces made from such additives, and for methods of making and using such additives, compositions, surfaces, and products.

It is yet another object of the present invention to provide for asphalt additives comprising an oil component of vegetable oil and/or crude tall oil, an amine component and an organosilane component, for asphalt compositions, products and surfaces made from or with such additives, and for methods of making and using such additives, compositions, surfaces, and products. Further embodiments of this embodiment include those in which the oil component comprises vegetable oil and crude tall oil.

It is even still another object of the present invention to provide for asphalt additives comprising an oil component of vegetable oil and/or crude tall oil, an amine component and an organosilane component, for asphalt compositions, products and surfaces made from or with such additives, for asphalt compositions, products and surfaces made from such additives which also include recycled asphalt material, for asphalt compositions, products and surfaces made from such additives which also include rejuvenated asphalt material, and for methods of making and using such additives, compositions, surfaces, and products. Further embodiments of this embodiment include those in which the oil component comprises vegetable oil and crude tall oil.

It is even yet another object of the present invention to provide for a compatible additive package that will reduce the number of additives the customer will need to keep in inventory at the terminal or mixing plant and/or asphalt binder terminal.

It is still even another object of the present invention to provide for a compatible additive package that will eliminate the need for multiple injection or dosing points at the plant for multiple additives.

It is still yet another object of the present invention to provide for a compatible additive package that will provide flexibility to the contractor to use different aggregates sources or higher RAP or RAS contents that were previously restrictive and difficult to use during plant production.

It is yet even another object of the present invention to provide for a compatible additive package that facilitate production and laydown of asphalt mixture at hot-mix, warm-mix, and cold-mix temperatures while achieving compaction.

It is yet still another object of the present invention to provide for a compatible additive package that will be cost competitive as a multi-purpose tool to be used by asphalt contractors and asphalt terminals in the industry

These and other objects will become apparent to those of skill in the art upon review of this specification, including its drawings and claims. According to one embodiment of the present invention, there is provided an asphalt additive comprising an oil component comprising vegetable oil and/or crude tall oil, an amine component, and an organosilane component.

According to another embodiment of the present invention, there is provided an asphalt binder comprising asphalt, an oil component comprising vegetable oil and/or crude tall oil, an amine component, and an organosilane component.

According to even another embodiment of the present invention, there is provided an asphalt article comprising asphalt, an oil component comprising vegetable oil and/or crude tall oil, an amine component, and an organosilane component. In further embodiments of this embodiment, the article is pavement, shingle, flooring or substrate.

According to still another embodiment of the present invention, there is provided a method of forming an asphalt mix comprising contacting asphalt binder, aggregate, an oil component comprising vegetable oil and/or crude tall oil, an amine component, and an organosilane component. In further embodiments of this embodiment, the contacting is carried out at a temperature greater than 300° F. to form a hot mix asphalt. In further embodiments of this embodiment, the contacting is carried out at a temperature in the range of about 220 to about 290° F. to form a warm mix asphalt. In further embodiments of this embodiment, the contacting is carried out at a temperature in the range of about 120° F. at about 212° F. to form a half-warm mix asphalt. In further embodiments of this embodiment, the contacting is carried out at a temperature in the range of about 45° F. at about 180° F., and in the presence of a solvent to form a cold-mix asphalt. In further embodiments of this embodiment, the contacting is carried out at ambient temperature, and in the presence of a solvent to form a cold-mix asphalt.

According to yet another embodiment of the present invention, there is provided a method of treating an asphalt article comprising contacting the article with a treatment composition comprising asphalt binder, an oil component comprising vegetable oil and/or crude tall oil, an amine component, and an organosilane component. In further embodiments of this embodiment. The method of claim 16, wherein the contacting is carried out using water foaming. In further embodiments of this embodiment. The method of claim 16, wherein the contacting is carried out using a mist application.

According to even still another embodiment of the present invention, there is provided a method of treating recycled asphalt comprising contacting the recycled asphalt with a treatment composition comprising asphalt binder, an oil component comprising vegetable oil and/or crude tall oil, an amine component, and an organosilane component.

According to even yet another embodiment of the present invention, there is provided a method of forming a foam. The method may include forming an asphalt mixture comprising asphalt binder, an oil component comprising vegetable oil and/or crude tall oil, an amine component, and an organosilane component. The method may also include injecting water into the asphalt mixture while the asphalt mixture is at a temperature greater than 212 F. The method may also include allowing at least a portion of the water to steam and for at least a portion of the asphalt mixture to foam.

For all of the above embodiments, further embodiments are provided wherein the vegetable oil comprises at least one selected from the group consisting of canola oil, castor oil, coconut oil, corn oil, cottonseed oil, distilled tall oil, flax seed oil, jetropa oil, linseed oil, mustard, oil, olive oil, palm oil, peanut oil, rapeseed oil, safflower oil, sesame oil, sunflower oil, soybean oil, soy oil (biodiesel), castor oil, tung oil, tigernut oil, and linseed oil, wherein the amine component comprises at least one selected from the group consisting of Triethanolamine (TEA), Diethanolamine (DEA), Pentaethylenehaxamine (PEHA), Ethylenediamine (EDA), Triethylenetetramine (TETA), Tetra-ethylenepentamine (TEPA), octoxyethylamine, decoxyethylamine, dodecoxyethylamine, tetradecoxyethylamine, hexoxypropylamine, octoxypropylamine, nonoxypropylamine, decoxypropylamine, dodecoxypropylamine, tetradecoxypropylamine, palmityloxypropylamine, myristyloxypropylamine, hexyl dioxyethylene oxyethylamine, octyl trioxyethylene oxyethylamine, dodecyl tetraoxyethylene oxyethylamine, myristyl dioxyethylene oxypropylamine, octyl tetraoxyethylene oxypropylamine, dodecyl tetraoxyethylene oxypropylamine, octyl dioxypropylene oxypropylamine, decyl trioxypropylene oxyethylamine, tetradecyl tetraoxypropylene oxypropylamine, octyl oxypropylene oxypropylamine, palmityl tetraoxypropylene oxypropylamine, heptenyl oxypropylene oxypropylamine, decenyl dioxyethylene oxyethylamine, octenyl oxypropylene oxyethylamine, dodecenyl tetraoxypropylene oxypropylamine, octyloxybutylene oxbutylamine, decyl trioxybutylene oxybutylamine, dodecyl tetraoxybutylene oxyethylamine, palmityl dioxybutylene oxypropylamine, decyl tetraoxy propylene oxypropylamine, and dodecyloxy propylene oxyethylamine; and wherein the organosilane comprises at least one selected from the group consisting of alkylsilanes, dialkylsilanes, polyalkylsilanes, organohalosilanes, organodihalosilanes, organopolyhalosilanes, oxalkylsilanes. aminosilanes, vinyl silanes, epoxy silanes, methacryl silanes, alkylsilanes, phenyl silanes, and halosilanes.

For all of the above embodiments, further embodiments are provided wherein the vegetable oil comprises at least one selected from the group consisting of corn oil, sunflower oil and jetropa oil, wherein the amine component comprises at least one selected from the group consisting of Triethanolamine (TEA), Diethanolamine (DEA) and Tetra-ethylenepentamine (TEPA), and wherein the organosilane comprises at least one selected from the group consisting of aminopropyltriethoxysilane, and epoxy silane.

For all of the above embodiments, further embodiments are provided wherein the vegetable oil comprises corn oil, wherein the amine component comprises at least one selected from the group consisting of Triethanolamine (TEA) and Diethanolamine (DEA), and wherein the organosilane comprises aminopropyltriethoxysilane.

For all of the above embodiments, further embodiments are provided wherein the oil component comprises vegetable oil and crude tall oil.

These and other embodiments of the present invention will become apparent to those of skill in the art upon review of this specification, including its drawings and claims.

### BRIEF DESCRIPTION OF THE DRAWINGS

FIG. 1 is a table showing plant mix extracted PG data.

FIG. 2 is a table showing plant mix volumetric data.

FIG. 3 is a table showing adhesion enhancement data.

FIG. 4 is a table showing water enhancement data.

FIG. 5 is a table showing pavement surface spray application data.

FIG. 6 is a table showing the proof of additive influence on viscosity of recycled mixes to provide the warm mix effect and rejuvenation effect.

### DETAILED DESCRIPTION OF THE INVENTION

The present invention provides for asphalt additives, for asphalt compositions, for asphalt articles comprising and/or made from such additives, for rejuvenated asphalt compositions and articles containing recycled asphalt, for methods of rejuvenating asphalt compositions and articles, and for methods for making and using such compositions and articles. The present invention finds application with a wide variety of asphalt compositions and articles, including but not limited to paving, road surfaces, parking lots, runways, sports and playground surfaces, railway tracks, bridge decks, floorings, roofing materials, roofing coatings, sealants, cattle sprays, lumber weatherproofing, paint, and Japan black (a lacquer or varnish also known as Japan lacquer or Brunswick black).

The present asphalt additive provides for active adhesion not provided by the prior art compositions. The classical mechanism of anti-strip functioning is through a surfactant effect wherein the active component of the present additive is composed of a hydrocarbon log chain with amine functionality at the opposite end. The hydrocarbon chain has an affinity for the asphalt binder and associates with it and the amine functionality associates with the aggregate particle surface and in this way active adhesion of the asphalt binder is promoted onto the aggregate surfaces. Therefore, conventionally, the potency or strength of the anti-strip agent is measured by the amine value i.e. the higher the amine value, the more potent the anti-strip is considered to be.

However, in the case of some non-limiting embodiments the present additive, the adhesion of the asphalt binder onto the aggregate takes place through a different mechanism: (i) the polar and low viscosity component of the additive derived from mixed vegetable oils lowers the surface tension of the asphalt binder and caused a good wetting out of the aggregate surfaces with asphalt binder; and (ii) a catalyst active bonding agent in the additive completes the bonding of the binder onto the aggregate surface. Therefore the additive is virtually independent of amine value for its functionality as an anti-strip agent and therefore works across a wider variety of different aggregates than conventional anti-strip agents.

Additive compositions of the present invention may include: (i) an oil component; (ii) an amine component; and/or (iii) an organosilane component. The present invention includes asphalt compositions, products and surfaces, which will include not only the additive composition, but may also include virgin asphalt and/or recycled asphalt. The oil component may comprise any one of the suitable oils discussed below, and also mixtures of two, three, four or more of those oils. The amine component may comprise any one of the suitable amines discussed below, and also mixtures of two, three, four or more of those amines. The organosilane component may comprise any one of the suitable organosilanes discussed below, and also mixtures of two, three, four or more of those organosilanes.

While in many non-limiting embodiments of the present invention, the additive will be preformed and added to or contacted with an asphalt, or added to an asphalt composition, other non-limiting embodiments anticipate using the various distinct components of the additive. As a non-limiting example bringing all three of the oil component, amine component and the organosilane component into contact with an asphalt composition or asphalt article. The oil, amine and organosilane components may be brought into contact with the asphalt composition or article simultaneously, or sequentially in any order, or first with one component and next with the other two components, or first with two components and then with the other one component. For many embodiments, whether the oil, amine and organosilane components are provided/utilized as a preformed additive, or utilized as distinct components will not matter. Of course, there are benefits to utilizing a preformed additive. In some embodiments, it will be necessary to utilize a preformed additive. As a non-limiting example, polyphosphoric acid (PPA) is a modifier that is used for asphalt binders. However, most amine based anti-strip agents are not compatible with such PPA modified binders due to a neutralization of the amine by the acid resulting in loss of adhesion as well as loss of stiffness modulus of the binder. However, as a unique feature of the additive of the present invention which does contain an amine component, that in spite of the amine component, the additive is perfectly compatible with such PPA modified binders.

Thus, the present invention also provides for compositions and articles comprising PPA modified asphalt and the additive, as well as methods comprising contacting together such PPA modified asphalt and the additive of the present invention.

As broad ranges, the various embodiments of the additives of the present invention may comprise a weight ratio of oil component:amine component:organosilane component of 10-99:0.1-25:0.1-40. More narrowly, the various additive embodiments will comprise an oil component in the range to/from or between any two of the following: 10, 15, 20, 25, 30, 35, 40, 45, 50, 55, 60, 65, 70, 75, 80, 85, 90, 95, or 99, parts by weight. And will comprise an amine component in the range to/from or between any two of the following: 0.1, 5, 10, 15, 20, or 25, parts by weight. And, will comprise an organiosilane component in the range to/from or between any two of the following: 0.1, 1, 2, 3, 4, 5, 6, 7, 8, 9 10, parts by weight. It should be understood that the additive may comprise other components as are known in the asphalt art, as these are only the relative parts by weight of the oil component, amine component and organosilane component.

As used in the present invention, the additive, when incorporated into asphalt binder or mix containing recycled materials such as Reworked Asphalt Pavement (RAP) and/or Reworked Asphalt Shingles (RAS), is able to disperse the asphaltenes in the aged RAP and RAS binders and co-mingle these aged binders with virgin binder added to restore the total binder to the target Performance Grading of the binder as if all new binder was used. That is, the additive will act as a rejuvenator and will rejuvenate the recycled asphalt. Thus, a rejuvenated mix will comprise the additive (or its components) and RAP and/or RAS, and may or may not further include virgin asphalt material. As shown by example data below (see, Examples), the addition of the additive (or its components) will rejuvenate the aged recycled binders and to move the PG back into the target PG Box desired.

Without being limited by theory, the inventors believe that the rejuvenator effect provided by the present invention is derived from the ability of the additive to disperse the asphaltenes in the aged recycled components (RAP and RAS), and from the polar chemistry based upon the vegetable oils with high polar content.

The additive of the present invention will also deliver full warm wix and cool mix benefits in mixing, handling, transportation, lay-down and compaction.

The War Mix effect is derived from the ability of the polar asphaltenes dispersion components in the additive to lower the viscosity of the co-mingled aged plus virgin binder significantly and to make the mix easily workable even at reduced mixing, laydown and compaction temperatures. This effect is clearly demonstrated by the differences in viscosity of the batch mixes tested with and without the additive.

Unlike the prior art, the Warm Mix effect provided by the present invention is not derived from “lubricity” of any surfactant component.

In cases where recycled components are not used such as in virgin mixes, the additive may still be used at 0.5% and above by weight of the asphalt binder to produce a full Warm Mix effect. However, in the case of recycled mixes containing RAP or RAP plus RAS and the desired effect is the rejuvenation and restoration of the total mix binder PG to a target PG, the actual level of additive needs be assessed by binder extraction and Performance Grading testing and dosage of the additive to confirm that the target PG has been achieved. However, with a longer term usage of the additive, a sufficiently large data base may be established to drive the dosage levels form such a data base.

Although commercial products exist which provide for a combined Warm Mix plus rejuvenator, the present invention provides a Warm Mix plus rejuvenation plus anti-strip plus water foaming enhancement plus surface rejuvenation as a single product concept. This differentiates some other commercial applications where for example the prior art Warm Mix additive and prior art rejuvenator cannot be mixed together and dosed as a single mixed additive due to chemical and physical incompatibility between the two additives, and the prior art teaches to never mix the two additives.

Various oils are known for being useful in the rejuvenation of asphalt, and any are suitable for use as the oil component in the present invention. For example, as discussed in U.S. Pat. No. 6,186,700, and herein incorporated by reference, rejuvenating oils have been found to be highly advantageous in softening up the asphaltic bituminous within the recycled asphalt roofing waste (RARW) recycled asphalt pavement (RAP), and in recycled asphaltic mixture (RAM), which is a blend RARW and RAP. Various petroleum products may be used in lieu of a rejuvenating oil as a viscosity modifier such as fuel oil, kerosene, mineral spirits, gasoline, flux oil, mist oil, used motor, hydraulic or heat exchanger oil and the like. Other commonly used rejuvenating agents or viscosity modifiers for RAP include low-viscosity products obtained by crude oil distillation or other hydrocarbon oil-based materials (see, e.g., U.S. Pat. No. 5,766,333 or 6,117,227). In addition, oil of plant origin have also been described as rejuvenating oils. See, for example, U.S. Pat. No. 7,811,372 (rejuvenating agents comprising bitumen and palm oil); U.S. Pat. No. 7,008,670 (soybean oil, alkyl esters from soybean oil, and terpenes used for sealing or rejuvenating); US Patent Application Publication No. 2010/0034586 (rejuvenating agent based on soybean, sunflower, rapeseed, or other plant-derived oils); and US Patent Application Publication No. 2008/0041276 (plasticizers for recycled asphalt that may be vegetable oils or alkyl esters made from vegetable oils). US Patent Application No. 2011/0015312 describes a binder composition comprising a resin of vegetable origin, a vegetable oil, and a polymer having anhydride, carboxylic acid, or epoxide functionality, but this binder is not specifically taught for rejuvenation; and rejuvenating agents derived from cashew nut shell oil, which contain mostly cardanol, a phenolic compound having a Ci5 unsaturated chain (see, e.g., WO 2010/077141 and WO 2010/110651). All of the patents and publications in this paragraph are incorporated by reference.

Some embodiments of the present invention utilize vegetable oil and/or crude tall oil (CTO) as the oil component, with preferred embodiments comprising crude tall oil and one or more vegetable oils. Generally, when mixtures of vegetable oil and/or crude tall oil are utilized as the oil component, they will be heated to a minimum of 250 F for a minimum of 1 hour to drive off any water that might be present and to complete the sterification reaction. Mixtures of vegetable oil and crude tall oil that are suitable for use as the oil component of the present invention generally comprise a weight ratio of vegetable oil:crude tall oil in the range of about 5-95:5-95. More narrowly, the oil component will comprise vegetable oil in the range to/from or between any two of the following: 5, 10, 15, 20, 25, 30, 35, 40, 45, 50, 55, 60, 65, 70, 75, 80, 85, 90, or 95 parts by weight. And will comprise crude tall oil in the range to/from or between any two of the following: 5, 10, 15, 20, 25, 30, 35, 40, 45, 50, 55, 60, 65, 70, 75, 80, 85, 90, or 95 parts by weight.

Suitable vegetable oils include canola oil, castor oil, coconut oil, corn oil, cottonseed oil, distilled tall oil, flax seed oil, jetropa oil, linseed oil, mustard, oil, olive oil, palm oil, peanut oil, rapeseed oil, safflower oil, sesame oil, sunflower oil, soybean oil, soy oil (biodiesel), castor oil, tung oil, tigernut oil, linseed oil, and waste vegetable oils. The preferred vegetable oil comprises corn oil, sunflower oil and/or jetropa oil, with corn oil being the most preferred.

The crude tall oil utilized in the present invent is generally characterized as a by-product of the paper manufacturing process through the digestion of wood pulp. Both man-made and natural produced tall oil and tall oil derivatives may be used to create the tall oil component of the present invention. Normally crude tall oil contains rosins (which contains resin acids (mainly abietic acid and its isomers), fatty acids (mainly palmitic acid, oleic acid and linoleic acid) and fatty alcohols), unsaponifiable sterols (5-10%), some sterols, and other alkyl hydrocarbon derivates. However, while the composition of crude tall oil varies a lot, depending on the type of wood used, and while the acid number of crude oil varies a lot, for example, with pure pines it is possible to have acid numbers in the range 160-165, while mills using a mix of softwoods and hardwoods might give acid numbers in the range of 125-135, it should be understood that any type of crude tall oil is believed to be suitable for the present invention.

Amines are well known as anti-strip agents in asphalt compositions, and any amines known for use in asphalt mixes are suitable for use in the present invention to provide anti-strip functionality. In general, amines suitable for use in the present invention may be primary, secondary, or tertiary, and which contains from about 1 to about 18 carbon atoms.

Non-limiting examples of amines suitable for use with the present invention include, but are not limited to: Triethanolamine (TEA), Diethanolamine (DEA), Pentaethylenehaxamine (PEHA), Ethylenediamine (EDA), Tri ethylenetetramine (TETA), Tetra-ethylenepentamine (TEPA), and mixtures of two or more of the above amines. Preferred amines include Triethanolamine (TEA), Diethanolamine (DEA), and Tetra-ethylenepentamine (TEPA), and the more preferred amines include Triethanolamine (TEA) and Diethanolamine (DEA).

By way of yet further illustration, the amines of the present invention may also include those disclosed in U.S. Pat. No. 4,038,102, the entire disclosure of which is hereby incorporated by reference into this specification. Examples from the '102 patent include but are not limited to octoxyethylamine, decoxyethylamine, dodecoxyethylamine, tetradecoxyethylamine, hexoxypropylamine, octoxypropylamine, nonoxypropylamine, decoxypropylamine, dodecoxypropylamine, tetradecoxypropylamine, palmityloxypropylamine, myristyloxypropylamine, hexyl dioxyethylene oxyethylamine, octyl trioxyethylene oxyethylamine, dodecyl tetraoxyethylene oxyethylamine, myristyl dioxyethylene oxypropylamine, octyl tetraoxyethylene oxypropylamine, dodecyl tetraoxyethylene oxypropylamine, octyl dioxypropylene oxypropylamine, decyl trioxypropylene oxyethylamine, tetradecyl tetraoxypropylene oxypropylamine, octyl oxypropylene oxypropylamine, palmityl tetraoxypropylene oxypropylamine, heptenyl oxypropylene oxypropylamine, decenyl dioxyethylene oxyethylamine, octenyl oxypropylene oxyethylamine, dodecenyl tetraoxypropylene oxypropylamine, octyloxybutylene oxbutylamine, decyl trioxybutylene oxybutylamine, dodecyl tetraoxybutylene oxyethylamine, palmityl dioxybutylene oxypropylamine, decyl tetraoxy propylene oxypropylamine, and dodecyloxy propylene oxyethylamine.”

By way of further illustration, the amines of the present invention may also be selected from those disclosed in U.S. Pat. No. 4,721,159, U.S. Pat. No. 2,582,823 and U.S. Pat. No. 2,582,824 and U.S. Pat. No. 2,469,728, all of which are herein incorporated by reference.

By way of yet further illustration, the present invention may utilize one or more of the amine compositions disclosed in U.S. Pat. No. 5,064,571, the entire disclosure of which is hereby incorporated by reference into this specification. These include mixtures of amido-amines prepared by a process comprising reacting at least one first component comprising at least one compound selected from the group consisting of mono- and dicarboxylic acids and acid esters, with a second component comprising polyoxyalkyleneamine bottoms products, where the reaction is conducted in the temperature range from about 25° to about 280° C. and at a pressure in the range from about atmospheric to about 200 psig.

By way of further illustration, the present invention may also utilize one or more of the hydroxylamines described in U.S. Pat. No. 6,290,772, the entire disclosure of which is hereby incorporated by reference into this specification. These include a hydroxylamine selected from the group consisting of N,N-bis(2-hydroxyethyl)-2-propanolamine and N,N-bis(2-hydroxypropyl)-N-(hydroxyethyl)amine, and alkanolamines such as monoethanolamine, diethanolamine, triethanolamine.

By way of further illustration, the present invention may also utilize one or more of the amines disclosed in U.S. Pat. No. 6,290,772, U.S. Pat. Nos. 4,990,190, 5,017,234 and U.S. Pat. No. 5,084,103, including certain higher trihydroxyalkylamines such as triisopropanolamine (hereinafter referred to as “TIPA”) and N,N-bis(2-hydroxyethyl)-2-hydroxypropylamine (hereinafter referred to as “DEIPA”).

The organosilanes of the present invention may be described as any organic derivative of a silane containing at least one carbon to silicon bond. As another description, the organosilanes of the present invention are a group of chemical compounds derived from silanes containing one or more organic groups. By way of non-limiting example, suitable organosilanes include those disclosed in U.S. Pat. No. 4,375,988, herein incorporated by reference.

Non-limiting examples of suitable organosilanes include, alkylsilanes, dialkylsilanes, polyalkylsilanes, organohalosilanes, organodihalosilanes, organopolyhalosilanes, oxalkylsilanes. aminosilanes, vinyl silanes, epoxy silanes, methacryl silanes, methacryloxy-silanes, alkylsilanes, phenyl silanes, sulfide-silanes, and halosilanes.

Alkylsilane examples include methylsilane, 3-(Trimethylsilyl)propanoic acid, Trimethyl(trifluoromethyl)silane, and Trimethylsilanecarbonitrile.

Dialkylsilane examples includes Dimethylsilane.

Polyalkylsilane examples include Trimethylsilane, Triethylsilane, Tetramethylsilane and Hexamethyldisilane.

Organochlorosilane examples include Chlorodimethylsilane and Chlorotrimethylsilane

Organodichlorosilane examples includes Dichlorodimethylsilane.

Organopolychlorosilane examples include Trichloro(methyl)silane, Trichloro(chloromethyl)silane, Trichloro(ethyl)silane, and Trichloro(octadecyl)silane.

Oxalkylsilanes examples include Diethoxydimethylsilane, Triethoxysilane, (3-Aminopropyl)triethoxysilane, Trimethoxy(octadecyl)silane, Tetramethyl silicate, and Tetraethyl silicate.

Other examples of suitable organosilanes include Ethenylsilane, Trimethylsilanol (an example of an organosilanol), Tris(tert-butoxy)silanethiol (an example of an organosilanethiol), Iodotrimethylsilane (an example of an organoiodosilane), and ethynyltrimethylsilane.

Still other examples of suitable organosilanes include: Trichlorosilane; Chloropropyltrichlorosilane; Chloropropyltriethoxysilane (Cl—C₃ H₆—Si(OC₂ H₅)₃); Chloropropyltrimethoxysilane (Cl—C₃ H₆—Si(OCH₃)₃); Vinyltrichlorosilane; Vinyltriethoxysilane (H₂C═CH—Si(OC₂ H₅)₃); Vinyltrimethoxysilane (H₂ C═CH—Si(OCH₃)₃); Vinyl-tris-(β-methoxy-ethoxy)silane; H₂ C═CH—Si(O—C₂ H₄—O—CH₃)); Vinyl triacetoxysilane (H₂ C═CH—Si(—OOC—CH₃)₃); Vinyltris(t-butylperoxy)silane; (H₂ C═CH—Si(OO C₄ H₉)₃; Vinylmethyldiethoxysilane; β-(N-vinylbenzylamino)ethyl-γ-amino-propyltrimethoxy-silane mono hydrogen chloride; γ-aminopropyltriethoxysilane (H₂N—CH₂—CH₂—CH₂—Si(OC₂H₅)₃; N,N-bis(β-hydroxyethyl)-γ-aminopropyl-triethoxysilane (OH—C₂ H₄)₂ N—C₃ H₆—Si(—O—C₂ H₅)₃; N-β-aminoethyl-γ-aminopropyl-trimethoxysilane (H₂ N—C₂ H₄—NH—C₃ H₆—Si(OCH₃)₃); N-β(aminoethyl)-γ-aminopropyl-ethyl-dimethoxysilane (H₂ N—C₂ H—NH—C₃ H₆—Si(CH₃)₂—C₂ H₅); Methyl(aminoethoxy-propyl-diethoxy)silane; (H₂ N—(CH₂)₂—O(CH₂)₃—Si(CH₃)₂—(OC₂ H₅)₂); Aminoethylaminopropyltridecyloxysilane (H₂ N—(CH₂)—NH—(CH₂)₃—Si(OC₁₀ H₂₁)₃; γ-mercaptopropyltrimethoxysilane; Cyclohexylamino-propyltrimethoxysilane; γ-methacrylyloxypropyltriethoxysilane (H₂ C═C(CH₃)COO—(CH₂)₃—Si(OC₂ H₅)₃); γ-methacrylyloxypropyl-tris(2-methoxyethoxy)silane (H₂ C═C(CH₃)COO—(CH₂)₃—Si(OC₂ H₄—OCH₃)₃); β-(3,4-epoxycyclohexyl)ethyltrimethoxysilane; Epoxycyclohexyltrimethoxysilane; γ-glycidopropyltriethoxysilane; and Methyltrimethoxysilane Vinyltriethoxysilane H₂ C═CH—Si(OC₂ H₅)₃.

Still other non-limiting examples of suitable organosilanes includes sulfur-containing silanes, such as, e.g., Bis-(3-[triethoxysilyl-]propyl)tetra(sulfur hydride), Bis-(3-[triethoxysilyl-]propyl)tri(sulfur hydride) and/or Bis-(3-[triethoxysilyl-]propyl)di(sulfur hydride)

Still other non-limiting examples of suitable organosilane include those of the formula RnSi(OR)4-n with “R” being an alkyl, aryl, or organofunctional group and “OR” being an alkoxy or acetoxy group.

For the halosilanes, suitable halogens include fluorine (F), chlorine (Cl), bromine (Br), iodine (I), and astatine (At), and the artificially created element 117 (ununseptium). Most likely, the halogen is chlorine.

RnHmSiCl4-n-m is the basic structure of chlorosilane with “R” being an alkyl, aryl, or olefinic group. Non-limiting examples of suitable chlorosilanes include: Dimethyldichlorosilane; Methyldichlorosilane; Methyltrichlorosilane; Phenyltrichlorosilane; Trichlorosilane; Trimethylchlorosilane; Silicon tetrachloride and Vinyltrichlorosilane.

Preferred organosilanes useful in the present invention include aminopropyltriethoxysilane, and epoxy silane, with aminopropyltriethoxysilane being the most preferred.

The present invention also provides for adhesive agents for asphalt binders comprising organosilane and amine, wherein the organosilane and amine is selected from those described in this application. Products using that adhesive agent would comprise asphalt binder and the adhesive agent, or comprise adhesive agent, organosilane and amine. Methods include contacting asphalt binder with the adhesive agent, or its components.

The additive (rejuvenator) composition of the present invention provides a number of unique advantages over the prior art compositions, and those include:
1. Single reacted chemistry that provides Cracking Resistance, Active Adhesion Agent, Rejuvenation (Surface and Recycled Mix), Water Foaming Enhancement and Reduced Mixing and Compaction temperature all in one.
2. Unlike other additives such as warm-mix or anti-strips it may be a replacement for the virgin binder and in such instance not added in addition to the virgin binder (i.e. not top loaded).
3. The percentage of additive used can be small (0.1-10 wt % in virgin binder) or large (up to 90 wt % with virgin binder or 100 wt % with no virgin binder at all but just recycled binder), with weight percent based on weight of binder. Certainly, the particular amount of additive will depend upon the type of asphalt, the application and end use. For example, in water foaming or spray applications the additive may be utilized in the ranges to/from or between any two of the following 0.1, 1, 2, 3, 4, 5, 6, 7, 8, 9, or 10 wt %, based on the weight of the binder.
4. Dosage flexibility with the additive allows for mix design flexibility in terms of recycled content and reduction in mixing and compaction temperatures.
5. The additive will impart low temperature properties and fatigue and thermal cracking resistance to recycled and replacement binders to improve long term performance.
6. The Rejuvenation, Viscosity Modification, and Active Adhesion features are delivered from one additive package at the point of use.
7. The additive allows for the production of unconventionally high recycled or replacement components at conventional (or lower) mixing temperatures—this is a key benefit in that additional heat is not being utilized to facilitate the use of these components.
8. This process and additive does not rely on any pre-drying of the recycled or replacement component and is not dependent on controlling or adjusting the moisture content of the recycled component before entering the mixing drum or mixing chamber.
9. The setup, ie. the additive may be employed at smaller dosage levels for quick setting of the mix for normal paving or at higher dosage rate as a softening/workability agent to produce a controlled set time such as needed for Cold Mix stock piling and or bagging for later use. This permits the production of asphalt mixes for immediate paving and traffic load bearing as well as for storage and later paving as and when needed such as for emergency patching and pot-hole repairs after severe freeze and thaw cycles in winter.

The additive of the present invention provides for Single Additive Chemistry that is useful in Hot Mix, Warm Mix, Half-Warm Mix, Cold Mix applications, functions as a Rejuvenator, is also a Water Foaming Enhancer and is also an Active Adhesion Agent.

Various non-limiting embodiments of the present invention include the additive plus 0% to 10% of recycled or replacement asphalt binder content by total mix composition.

Various non-limiting embodiments of the present invention include the additive plus 0% to 10% virgin asphalt binder content by total mix composition.

Various non-limiting embodiments of the present invention include the additive comprising 5-95 weight percent CTO, 5-95 weight percent vegetable oil(s), 1-20 weight percent amine(s), and 0.05 to 10 weight percent organoilane(s), based on the total weight of the CTO, vegetable oil(s), amine and organosilane(s).

Various non-limiting embodiments of the present invention include combinations of an asphalt pavement comprising one or more of the elements as discussed above.

Various non-limiting embodiments of the present invention are applicable to neat binders, polymer modified binders and Ground Tire Rubber Binders and resultant mixes produced from such binders.

Various non-limiting embodiments of the present invention include High RAP and RAS additive that is combined Warm mix and the additive (rejuvenator) in restoring mix binder PG back to Target PG desired.

Various non-limiting embodiments of the present invention include Surface Rejuvenator when heated to reduce viscosity to be sprayed as Spray to Rejuvenate pavement surfaces.

Various non-limiting embodiments of the present invention include the additive being combined with safe vegetable based solvents non-limiting examples of which include soy methyl ester or similar, or with biodiesel or with any vegetable oil to reduce viscosity and increase penetration and applied as a Spray Surface Rejuvenator.

Various non-limiting embodiments of the present invention include the additive being combined with a “Green” emulsifier such as ethoxylated vegetable oils to form a Water Dispersible Concentrate that can be diluted with water at point of use and applied as a Surface Spray Rejuvenator.

Various non-limiting embodiments of the present invention include any combination of an asphalt pavement comprising one or more of the above elements.

Various non-limiting embodiments of the present invention include using the additive in a Green No-Tack Spray for paving and compaction equipment wheels to render tack free against freshly paved hot pavement.

Various non-limiting embodiments of the present invention include using the additive in a Green truck bin spray Release Agent to prevent the sticking of mixes onto truck bins after discharge of the mix load.

Various non-limiting embodiments of the present invention include a Warm Mix effect derived from the functioning of the blended and reacted vegetable oil components through binder viscosity reduction and the vegetable oils “slip effect.

Various non-limiting embodiments of the present invention include a Rejuvenation effect derived from asphaltenes dispersion effect of the polar components of the reacted vegetable oil mix.

Various non-limiting embodiments of the present invention include a High RAP & RAS Warm Mix and Rejuvenation effect derived from the significant and substantial viscosity reduction of the combined recycle and virgin binders of the mix.

Various non-limiting embodiments of the present invention include a Water Foaming Extension of Half-Life derived from influence upon surface tension of the binder and formation of uniform size air bubbles/globules that take longer time to break.

Various non-limiting embodiments of the present invention include use of the additive in Hot Mix to facilitate mixing, workability and compaction in cold weather and/or cold climates and/or elevated altitude paving.

Various non-limiting embodiments of the present invention include varying the ratio of additive to binder to extend or reduce workability and storage times of Cold Mixes.

Various non-limiting embodiments of the present invention include using the additive used in any type of mixing drum or batch mixer employed in the mixing of aggregates with binder.

Various non-limiting embodiments of the present invention include utilizing the additive to produce, haul, lay down and compact mixes in the temperature window of 350° F. and below and down to Cold Mix temperatures (less than 160° F.) and below.

Various non-limiting embodiments of the present invention include utilizing the additive to produce mixes without the need to completely dry the virgin or recycled aggregates.

Various non-limiting embodiments of the present invention include utilizing residual moisture remaining in the aggregates and/or recycled components to improve workability and compaction of the final mix through the benefit the embodiment described above.

Various non-limiting embodiments of the present invention include compatibility of the additive with most if not all of the aggregate sources currently commercially utilized. Even extreme aggregates not usable until now may be used by “tweaking” the additive to binder ratio. That is, less additive makes for a stiffer mix, and more additive makes for a softer mix.

Various non-limiting embodiments of the present invention include addition of the additive directly to the virgin binder.

Various non-limiting embodiments of the present invention include addition of the additive onto the recycled components as a spray upon entry of such components into the mixing plant.

Various non-limiting embodiments of the present invention include addition of the additive onto the recycle components by spraying and then stockpiling to marinate/pickle to activate the recycle binder.

Various non-limiting embodiments of the present invention include utilizing the additive to mix and pave 100% Recycled Mixes as combinations of RAP plus RAS or 100% RAP or 100% RAS.

The additive (rejuvenator) composition of the present invention is believed to find utility in a number of applications, including, but not limited to use with various polymers including: styrene-butadiene styrene (SBS), styrene-butadiene-rubber (SBR), ethylene vinyl acetate (EVA), reactive elastomeric terpolymer (RET), ethylene propylene diene monomer (EPDM), natural rubber (NR), ground tire rubber (GTR), polyphosphoric acid (PPA), latex and silicone rubber to further strengthen the final mix and bring extended long term durability. Also to provide enhancement for higher traffic load pavements.

Hot Mix, Warm Mix, Half-Warm Mix, Cold Mix Applications

The additive of the present invention may be utilized with any of the hot mix, warm mix, half-warm mix, cold mix applications. The various “mix” methods generally employ different temperatures, although it is important to note that sometimes temperature ranges overlap. The various application methods may be described as follows:

Hot Mix Asphalt is a conventional asphalt paving procedure utilizing highly heated aggregates and asphalt binder to create an asphalt pavement mixture. The asphalt pavement layers created can be base courses, intermediate courses or wearing courses. The asphalt mixtures created can be dense-graded, gap-graded, or open-graded. The typical composition is 4-8% asphalt binder with 96-92% aggregates/RAP/RAS. Of course, RAP usage varies from State-to-State, with typical usage being 25% RAP and maximum usage approximately 40% RAP. It is noted that RAS usage is more restricted with fewer States even allowing RAS. In States currently allowing RAS typical and maximum usage is 3-5% RAS. Typical mixing temperature is 300° F.+ (heated aggregates and liquid binder). It should be understood that the hot mix mixing may be carried out at any of the following specific temperatures, or at greater than any of the following temperatures, or may be in the range of to/from or between any two of the following temperatures 300° F., 305° F., 310° F., 315° F., 320° F., 325° F., 330° F., 335° F., 340° F., 345° F., 350° F., 355° F., 360° F., or 365° F. Of course, it should be understood that temperatures slightly lower that 300° F. may also be utilized. Higher mixing temperatures are typically utilized with higher recycled contents (most commonly RAP and RAS, but also Ground Tire Rubber).

Warm Mix Asphalt includes the hot mix description above, with the exception of reduced temperatures. Warm Mix requires using an additive which allows the contractor to produce the same hot-mixture at a temperature 50-100° F. lower than typical hot-mix temperatures without compromising the integrity of the mixture properties. Warm mix may be produced by adding either zeolites, waxes, asphalt emulsions, or sometimes even water to the asphalt binder prior to mixing. This allows significantly lower mixing and laying temperatures and results in lower consumption of fossil fuels, thus releasing less carbon dioxide, aerosols and vapors. Not only are working conditions improved, but the lower laying-temperature also leads to more rapid availability of the surface for use, which is important for construction sites with critical time schedules. The usage of these additives in hot mixed asphalt (above) may afford easier compaction and allow cold weather paving or longer hauls. More common temperature ranges for warm mix asphalt is mixing temperatures between 230-280° F. It should be understood that the warm mix mixing may be carried out at any of the following specific temperatures, or at less than any of the following temperatures down to about 215° F., or may be in the range of to/from or between any two of the following temperatures, 220° F., 225° F. 230° F., 235° F., 240° F., 245° F., 250° F., 255° F., 260° F., 265° F., 270° F., 275° F., 280° F., 285° F., or 290° F. Of course, it should be understood that temperatures slightly lower than 215° F. perhaps down to the boiling point of water, and slightly higher than 290° F. may also be utilized. Examples of additives currently used: (a) Water Foaming—Examples: Double Barrel Green, Terex, Aquablack; (b) Zeolites—Examples: Asphamin, Advera; (c) Chemical Packages—Examples: Evotherm 3G, Cecabase RT; (d) Specialized Waxes—Examples: Sasobit; and (e) Organic Additives—Examples: Hydrogreen. The reduction in temperature has environmental benefits with the lowering of harmful emissions (carbon dioxide, sulfur dioxide, nitrogen oxides, etc.). The reduction in temperature has cost benefits in the form of fuel savings as there is less fuel required to produce the asphalt mixture. The reduction in temperature has safety benefits for the paving crew who are not exposed to the harmful emissions. Reduction in temperature allows for earlier opening to traffic than hot mix asphalt.

Half-Warm Mix is an asphalt mix that is mixed and paved at the temperature window of 140 F to 212 F. It should be understood that the half-warm mix mixing may be carried out at any of the following specific temperatures, or at less than any of the following temperatures down to about 120° F., or may be in the range of to/from or between any two of the following temperatures, 125° F., 130° F., 135° F., 140° F., 145° F., 150° F., 155° F., 160° F., 165° F., 170° F., 175° F., 180° F., 185° F., 190° F., 200° F., 205° F., 210° F., or 212° F.

Cold Mix Asphalt is separated into two distinct categories.

Firstly, Cold Mix Asphalt is utilized as Patching or Pot-Hole Fill Mix, and is typically manufactured using solvents or biodiesels as a means to soften the asphalt binder and keep the mix workable at ambient temperature. Mixing temperature is restricted to below 180° F. due to the flammability of the solvents used. It should be understood that the cold mix mixing may be carried out at any of the following specific temperatures, or at less than any of the following temperatures down to about 45° F., or may be in the range of to/from or between any two of the following temperatures, 50° F., 60° F., 70° F., 80° F., 90° F., 100° F., 110° F., 120° F., 130° F., 140° F., 150° F., 165° F., 170° F., or 180° F.

The second Cold Mix Asphalt is Cold Central Plant Recycling, and this uses asphalt emulsions to coat aggregates, RAP, or a combination of the two and laydown as asphalt pavement layer. This process can also be done as Cold In-Place Recycling. The mixing process is typically performed at ambient temperature. It should be understood that the cold mix mixing may be carried out at any of the following specific temperatures, or at less than any of the following temperatures down to about 45° F., or may be in the range of to/from or between any two of the following ambient temperatures, 50° F., 60° F., 70° F., 80° F., 90° F., 100° F., 110° F., or 120° F. Once compacted, emulsions typically require a curing time before opening to traffic that exceeds that of hot mix and warm mix asphalt.

The rejuvenator compositions of the present invention may be utilized in traditional Hot Mix, Warm Mix, Half-Warm Mix and Cold Mix application processes. In the practice of the present invention, the rejuvenator additive is added to the binder that is then added to the mix in the drum (be it Hot, Warm or Cold). However, the additive may also be injected directly into the mix in the mixing drum (without blending with binder), or sprayed onto the mix components (aggregates and/or RAP and/or RAS) as it enters into the mixing drum. Alternatively, the additive can be premixed with the RAP and/or RAS and left to stock-pile for a period of hours, days, or weeks before feeding into the mixing drum. As discussed above, in some embodiments, the three components (oil, amine and organosilane) may be pre-formed into an additive and utilized, or the three components may be utilized as individual components and added simultaneously, sequentially, or one at a time followed by two at a time, or two at a time followed by one at a time.

Water Foaming

The basic idea of asphalt foaming is to inject a small quantity of cold water (usually with a mass ratio of 1% to 5% into the asphalt binder) together with compressed air into hot asphalt (140° C. to 170° C.) in a specially designed chamber. The hot asphalt must be at least hot enough to turn at least a portion of the cold water into steam. Thus, upon being injected into the asphalt binder, the water experiences a sudden temperature increase and becomes steam. When the mixture of asphalt cement, steam and compressed air is injected into the ambient air, asphalt is temporarily expanded into numerous bubbles with greatly increased surface area per unit mass. The purpose of asphalt foaming is to make it easier for asphalt to disperse into cold granular materials at ambient temperature. The additive of the present invention provides for an extension of the foam half-life.

Liquid asphalt binder at high temperature without foaming would immediately become globules when it contacts cold aggregates and thus cannot be thoroughly dispersed. On the other hand, foamed asphalt, or asphalt bubbles can be dispersed into the mix fairly uniformly.

In the practice of the present invention, when the rejuvenator additive composition (or alternatively, the various additives) is/(are) added to the asphalt binder before it is water foamed, benefits are: (a) Foam Half Life is extended by at least a factor of 2, 3 or 4 times making longer hauls of the mix possible. Further after the water has evaporated, the additive is left behind in the binder as a useful ongoing rejuvenating component. (b) The foam air bubbles formed are of a uniform air globule size i.e., a “cappuccino” foam. This means that the air pressure inside the small foam globules is lower and take longer to break thereby producing the longer half-life. This also addresses the problems of different asphalts (from different sources) foaming differently and makes the foaming more consistent and predictable. In conventional Water Foaming, air globules of a wide range in size is produced and the larger bubbles break faster. This quick breaking foaming is a major disadvantage in Cold Weather Paving (Fall, Spring & Winter) since the mix stiffens shortly after made and is difficult to lay down and compact. The additive package added to the binder before Water Foaming resolves such issues.

In conventional Water Foaming applications, the quantity of water used ranges from 2 to 4 liters of water per ton of asphalt binder and this is a wider range. Also, higher foaming temperatures are employed to make the binder produce adequate foaming and consequent extended haul time and workability of the mix. Further, not all asphalt binders foam the same and some are actually very difficult to foam and this is because of the variation in the asphalt composition and resulting differences in surface tension properties of the different binders.

In Fall and in Spring, mixing plants employing Water Foaming, encounter serious problems of the mix setting up and becoming stiff and unworkable even with short haul distances and some mixing plants have had such unworkable mixes returned from Customers. Further in Water Foaming, the variations in quantity of water used, different range of temperatures employed and differences in asphalt binder surface tension result in a wide distribution in the globule sizes of air bubbles formed. The larger bubbles have a higher internal pressure and burst earlier and thereby deprive the mix of lubricity and the associated workability. This explains why such Water Foamed mixes become stiff in a short space of time presenting sudden difficulties in workability and compaction.

When the additive (or the components) is/(are) injected into the hot binder and then foamed by water injection, the additive changes the surface tension properties of the binder which results in about 20% less foam than otherwise, but more importantly the foam generated is a “cappuccino” foam of a much smaller globule size and of a narrow globule size distribution. Since these air bubbles are smaller with lower internal pressure, these take a longer time to break so that a larger population of air bubbles remains in the mix for a longer time period to extend the foam half-life to provide the desired lubricity for longer hauls, workability and compaction.

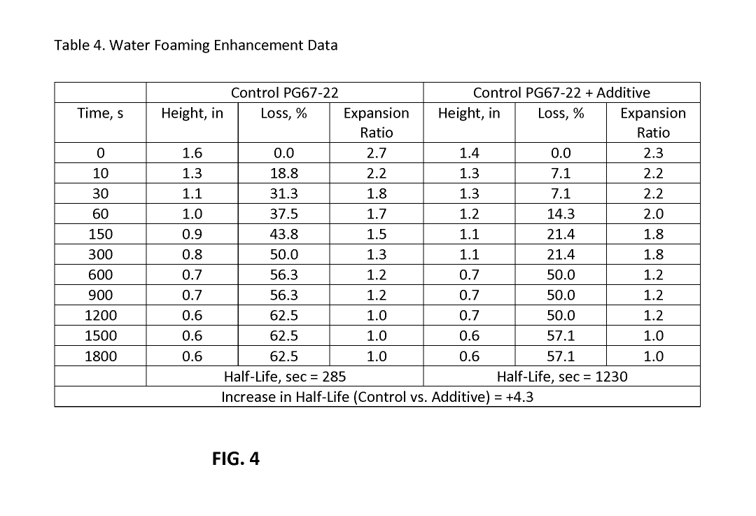

As found in the Example section below (Refer to Table 4, see FIG. 4), the data clearly demonstrates that the Foam Half-Life is extended by a factor of 4.4 times versus the same Control mixture foamed without the additive. Water Foaming is by far the largest Warm Mix Technology practiced in the USA and the additive makes the application even more robust and solves much of the Industry issues related to premature stiffening of the mix.

Furthermore, in conventional Water Foaming, after the foam bubbles collapse and the moisture evaporates nothing beneficial is left in the mix. On the other hand the additive remains incorporated in the binder as a Rejuvenator, Viscosity Modifier, and Adhesion Promoter.

For most water foaming applications, the additive may be utilized in the ranges to/from or between any two of the following 0.1, 1, 2, 3, 4, 5, 6, 7, 8, 9, or 10 wt %, based on the weight of the binder. A common range would be from about 0.1 to about 5 wt % additive, based on the weight of the binder.

Fog/Mist Application

A few years (typically after 2 to 3 years) after a surface is paved, it is oxidized by sunlight, traffic loadings, seasonal temperature changes, and rain. This results in a dull pavement and the cohesive and adhesive strength of the surface can be compromised to result in cracking and raveling (surface granules coming loose under traffic tires shear forces).

Surface Rejuvenation Sprays are applied to pavements to rejuvenate the pavement surface, to prevent the binder from aging and degrading and losing its adhesive and cohesive strength, and to prolong the life of the pavement through this minimal maintenance program and cost.

The time for applying a Surface Rejuvenator is generally: (a) About 12 to 24 months after the surface is paved, a Rejuvenator is applied by Fog/Mist Application to protect the surface from oxidation and rapid aging to prolong the useful life of the pavement. (b) When the first signs of surface aging is observed (typically 2 to 3 years) a Fog/Mist Rejuvenator is applied to extend the useful life of the pavement.

A fog (or mist) seal is an application of a specially formulated asphalt emulsion (a thin liquid oil) to an existing asphalt pavement surface. A fog seal gets its name from its spray application, sometimes referred to as “fogging.”

In the practice of the present invention, the rejuvenator and/or viscosity modifier additive (or its components) of the present invention will be added to the fog seal asphalt emulsions used in fog seal applications. Those emulsions may also include globules of paving asphalt, water, and an emulsifying agent or surfactant. Soap is a common form of a surfactant. In washing clothes or dishes, the surfactant helps remove the dirt and suspend the dirt particles in the wash water. Similarly, in asphalt emulsions, the surfactant keeps the paving asphalt globules in suspension until it is applied to the pavement surface when the water in the asphalt emulsion starts to evaporate. For most fog seal applications, the additive may be utilized in the ranges to/from or between any two of the following 0.1, 1, 2, 3, 4, 5, 6, 7, 8, 9, or 10 wt %, based on the weight of the binder. A common range would be from about 0.1 to about 5 wt % additive based on the weight of the binder.

On existing asphalt pavement, fog seals are typically applied on either an intermittent or cyclical basis. Location, weather, traffic loading, and pavement conditions are factors used to determine if a fog seal application is appropriate. Roadways selected for fog seal treatment are commonly those which have minor cracking, faded color, or where a fog seal would help extend the pavement life until resurfacing becomes necessary. Roadways chosen for cyclical fog seal applications would typically be treated every three to five years. In desert areas, fog seals may be applied to new asphalt pavement to help protect it against oxidation and retain flexibility.

Fog seals are applied by a distributor truck. The distributor truck slightly heats the asphalt emulsion before spraying it onto the pavement. Once applied the surface has the appearance similar to the pavement having been spray painted black.

In the practice of the present invention, the spray mixtures may be formed from the additive, or from the components of the additive, and may or may not also include asphalt binder. Generally, a surface rejuvenation spray will comprise the additive without asphalt binder, whereas a rejuvenation seal will comprise not only the additive, but also an asphalt component (for example cut back asphalt). In the practice of the present invention, the additive (or the three components) may be used as a surface rejuvenation spray or even a rejuvenation seal in one of following ways:
(a) The additive (or the three components) is (are) heated to a suitable temperature to reduce the spray out viscosity and achieve the target spray out rate and sprayed as such utilizing a distributor conventionally used for such spray applications. In many embodiments, heating the additive to a temperature between to between 120° F. and 175° F. is suitable, but of course, higher or lower temperatures may be utilized, as necessary to reduce the spray out viscosity and achieve the target spray out rate.
(b) The additive (or three components) may be diluted with a suitable solvent that will allow it to be sprayed out as desired. Non-limiting examples of suitable solvents include aliphatic naphtha, aliphatic kerosene, light vegetable oils, biodiesel, light cut bio-dolvents or other green and safe solvents (a non-limiting example of which is soy methyl ester). Spraying will generally be carried out at ambient temperatures or temperatures slightly above ambient ((eg. 100° F.+).
(c) Optionally, the additive (or its components) may be combined with a surfactant/emulsifier (forming an emulsifiable product) and then diluted with water at the point of use/application and sprayed out with a conventional distributor. The spraying is generally at temperatures ranging from ambient to less than the boiling point of water, as a non-limiting example, from ambient up to 120° F. to 185° F. It is noted that this emulsifiable product may be further combined with asphalt or asphalt emulsion and sprayed.

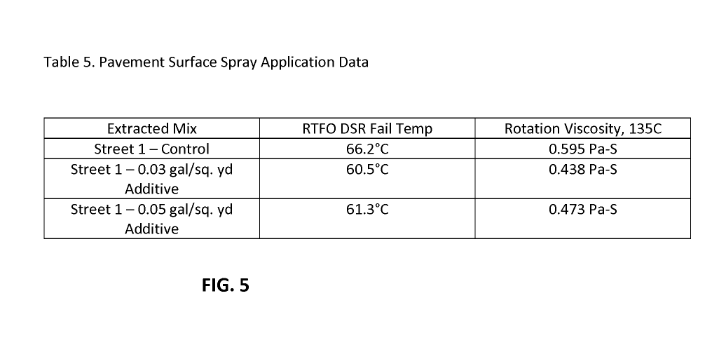

Of course, the above spray methods may further include an asphalt component. Additionally, the spray mixtures may be formed by adding the three components 1, 2 or 3 at a time, rather than as a pre-formed additive. With the additive of the present invention, surface binder may be rejuvenated by application of the additive, and this may be evidenced by a drop in the stiffness modulus of the binder. Such drop in stiffness prevents the binder from cracking and raveling and significantly delays the aging of the pavement. See Example 4 below, and see Table 5 (FIG. 5).

For any of the types of mixes, one non-limiting embodiment provides that the additive may be added to the binder which is then added to mix. However, other non-limiting embodiments provides that the additive may be added directly to mix in the mixing drum or sprayed onto mix components going into mixing drum or added to aggregates/RAP/RAS (separately or together) and left to “pickle” in stock piles before feeding into mixing drum.

### Examples

The following non-limiting example are being provided merely to illustrate some non-limiting embodiments of the present invention. They are not intended to and do not limit the scope of the claims.

### Example 1

### Effect of Additive on Rejuvenation of High RAP Mixes

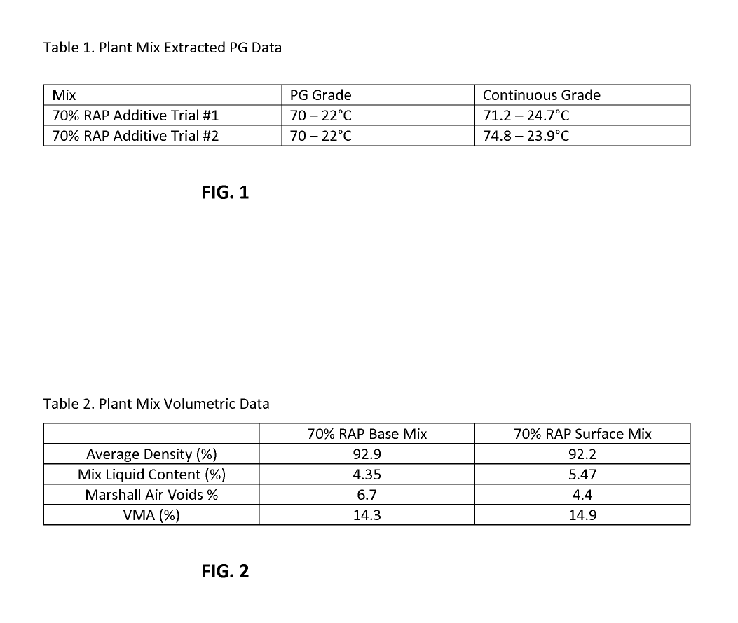

The example demonstrates the effectiveness of the additive to rejuvenate both Warm Mix and Cool Mix asphalt, with supporting date found in Table 1 (see, FIG. 1) showing the effect of the additive on rejuvenation of high RAP mixes”

The data demonstrates how the aged Recycled batch mix with PG 89.3-16.7 Performance Grading can be Rejuvenated to “young” binder PG 71.2-24.7 and PG 74.8-23.9 with the use of the additive.

The same result has also been demonstrated with RAS (Reworked Asphalt Shingles) showing the same rejuvenation effect with combinations of RAP plus RAP.

Comments: The additive has the ability to allow the incorporation of high amounts of recycled or replacement asphalt through conventional asphalt mixing drums. Table 1 data was generated through a Double Barrel mixing drum typically used to produce hot-mix asphalt mixture. The RAP PG Grade before the addition of the additive was PG89.3-16.7° C., use of the additive provides superior initial and long term performance properties based on the below testing. See results in Table 1 (FIG. 1).

Comments: Field Density data in Table 2 (see, FIG. 2) was generated on two different High RAP mixtures produced with the additive. Mix Liquid Content is combination of all soluble components of the asphalt mixture design (i.e. additive, virgin asphalt, recycled asphalt, replacement asphalt, etc). Both mixes were produced through a Double Barrel mixing drum at temperatures of 215° F.-240° F. and compacted at temperatures down to 170° F.

### Example 2

### Effect of Additive on Active Adhesion and Anti-Stripping Properties

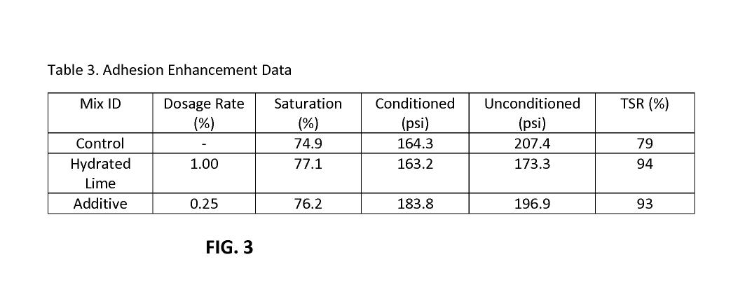

Comments: Tensile Strength Ratio (TSR) Test data shown in Table 3, (see, FIG. 3) demonstrates the ability of the additive to improve the moisture resistance of the asphalt mixture. Hydrated lime is commonly used in the hot-mix asphalt industry for the same purpose and is included here for comparison purposes. TSR requirements vary but typically 85% is the minimum required TSR % Ratio.

### Example 3

### Effect of Additive on Enhancement of Water Foaming and Extension of Foam Half-Life

Comments: The table 4 data (FIG. 4) demonstrates the ability of the additive to improve the half-life when used in conjunction with water foaming of the asphalt binder. An increase of 4.3 times the Control is seen which translates to a longer workability and compaction window.

### Example 4

### Effect of Additive on Surface Rejuvenation

Comments: The additive can be heated and applied to a pavement surface as a pavement preventive or maintenance product. Alternatively, the additive can incorporate a surfactant and be diluted with water and applied cold to the pavement surface for the same purpose. The Table 5 data (See, FIG. 5) is trial data performed using the latter technique. Extraction and PG data is taken from top ½″ of 10 cored specimens. Reduced RTFO DSR indicates a softer pavement surface and decreased likelihood of surface distresses leading to pavement failure.

### Example 5

### Proof of Additive Influence on Viscosity of Recycled Mixes to Provide the Warm Mix Effect and Rejuvenation Effect

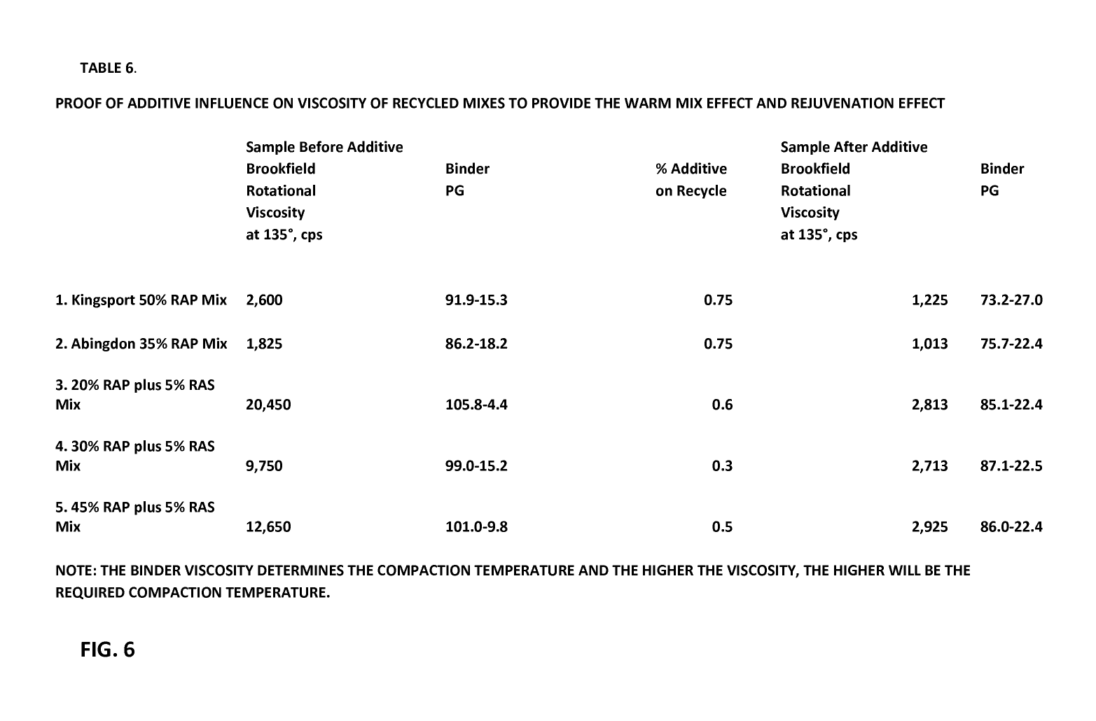

Utilizing ASTM D1856-09 (2015), a standard test method for recovery of asphalt from solution by the Abson method, binder is extracted from the aggregate mix with Trichloroethylene Solvent (TCE) under reflux conditions, with the binder recovered from the solvent by rotary evaporation of the TCE Solvent. The recovered binder is then tested by standard AASHTO Test Methods for the properties listed as shown in Table 6 (see, FIG. 6).

Any patents, publications, articles, books, journals, brochures, cited herein, are herein incorporated by reference.

While the present invention has been described as being useful for creating a bonded friction course pavement, it should be understood that the compositions, products and methods of the present invention may be utility in any form pavement not just bonded friction course pavement. The present invention may find utility for any type of asphalt application such as roads, runways, athletic tracks, speedway tracks, parking lots, roofing surfaces, driveways, playground surfaces, sports surfaces, and the like, be it as the top surface layer, or even as a below surface layer. The present invention may also be useful for creating a water-proof barrier between zones or around certain objects.

While the illustrative embodiments of the invention have been described with particularity, it will be understood that various other modifications will be apparent to and can be readily made by those skilled in the art without departing from the spirit and scope of the invention. Accordingly, it is not intended that the scope of the claims appended hereto be limited to the examples and descriptions set forth herein but rather that the claims be construed as encompassing all the features of patentable novelty which reside in the present invention, including all features which would be treated as equivalents thereof by those skilled in the art to which this invention pertains.

1. An asphalt additive comprising an amine component, and organosilane component, and oil component comprising at least selected from the group consisting of vegetable oil and a crude tall oil.

2. The additive of claim 1, wherein the vegetable oil comprises at least one selected from the group consisting of canola oil, castor oil, coconut oil, corn oil, cottonseed oil, distilled tall oil, flax seed oil, jetropa oil, linseed oil, mustard, oil, olive oil, palm oil, peanut oil, rapeseed oil, safflower oil, sesame oil, sunflower oil, soybean oil, soy oil (biodiesel), castor oil, tung oil, tigernut oil, and linseed oil, wherein the amine component comprises at least one selected from the group consisting of Triethanolamine (TEA), Diethanolamine (DEA), Pentaethylenehaxamine (PEHA), Ethylenediamine (EDA), Triethylenetetramine (TETA), Tetra-ethylenepentamine (TEPA), octoxyethylamine, decoxyethylamine, dodecoxyethylamine, tetradecoxyethylamine, hexoxypropylamine, octoxypropylamine, nonoxypropylamine, decoxypropylamine, dodecoxypropylamine, tetradecoxypropylamine, palmityloxypropylamine, myristyloxypropylamine, hexyl dioxyethylene oxyethylamine, octyl trioxyethylene oxyethylamine, dodecyl tetraoxyethylene oxyethylamine, myristyl dioxyethylene oxypropylamine, octyl tetraoxyethylene oxypropylamine, dodecyl tetraoxyethylene oxypropylamine, octyl dioxypropylene oxypropylamine, decyl trioxypropylene oxyethylamine, tetradecyl tetraoxypropylene oxypropylamine, octyl oxypropylene oxypropylamine, palmityl tetraoxypropylene oxypropylamine, heptenyl oxypropylene oxypropylamine, decenyl dioxyethylene oxyethylamine, octenyl oxypropylene oxyethylamine, dodecenyl tetraoxypropylene oxypropylamine, octyloxybutylene oxbutylamine, decyl trioxybutylene oxybutylamine, dodecyl tetraoxybutylene oxyethylamine, palmityl dioxybutylene oxypropylamine, decyl tetraoxy propylene oxypropylamine, and dodecyloxy propylene oxyethylamine; and wherein the organosilane comprises at least one selected from the group consisting of alkylsilanes, dialkylsilanes, polyalkylsilanes, organohalosilanes, organodihalosilanes, organopolyhalosilanes, oxalkylsilanes. aminosilanes, vinyl silanes, epoxy silanes, methacryl silanes, alkylsilanes, phenyl silanes, and halosilanes.

3. The additive of claim 1, wherein the oil component comprises vegetable oil and crude tall oil, and wherein the vegetable oil comprises at least one selected from the group consisting of corn oil, sunflower oil and jetropa oil, wherein the amine component comprises at least one selected from the group consisting of Triethanolamine (TEA), Diethanolamine (DEA) and Tetra-ethylenepentamine (TEPA), and wherein the organosilane comprises at least one selected from the group consisting of aminopropyltriethoxysilane, and epoxy silane.

4. The additive of claim 3, wherein the vegetable oil comprises corn oil, wherein the amine component comprises at least one selected from the group consisting of Triethanolamine (TEA) and Diethanolamine (DEA), and wherein the organosilane comprises aminopropyltriethoxysilane.

5. An asphalt binder comprising asphalt, an amine component, an organosilane component, an oil component comprising at least one selected from the group consisting of vegetable oil and a crude tall oil.

6. The binder of claim 5, wherein the vegetable oil comprises at least one selected from the group consisting of canola oil, castor oil, coconut oil, corn oil, cottonseed oil, distilled tall oil, flax seed oil, jetropa oil, linseed oil, mustard, oil, olive oil, palm oil, peanut oil, rapeseed oil, safflower oil, sesame oil, sunflower oil, soybean oil, soy oil (biodiesel), castor oil, tung oil, tigernut oil, and linseed oil, wherein the amine component comprises at least one selected from the group consisting of Triethanolamine (TEA), Diethanolamine (DEA), Pentaethylenehaxamine (PEHA), Ethylenediamine (EDA), Triethylenetetramine (TETA), Tetra-ethylenepentamine (TEPA), octoxyethylamine, decoxyethylamine, dodecoxyethylamine, tetradecoxyethylamine, hexoxypropylamine, octoxypropylamine, nonoxypropylamine, decoxypropylamine, dodecoxypropylamine, tetradecoxypropylamine, palmityloxypropylamine, myristyloxypropylamine, hexyl dioxyethylene oxyethylamine, octyl trioxyethylene oxyethylamine, dodecyl tetraoxyethylene oxyethylamine, myristyl dioxyethylene oxypropylamine, octyl tetraoxyethylene oxypropylamine, dodecyl tetraoxyethylene oxypropylamine, octyl dioxypropylene oxypropylamine, decyl trioxypropylene oxyethylamine, tetradecyl tetraoxypropylene oxypropylamine, octyl oxypropylene oxypropylamine, palmityl tetraoxypropylene oxypropylamine, heptenyl oxypropylene oxypropylamine, decenyl dioxyethylene oxyethylamine, octenyl oxypropylene oxyethylamine, dodecenyl tetraoxypropylene oxypropylamine, octyloxybutylene oxbutylamine, decyl trioxybutylene oxybutylamine, dodecyl tetraoxybutylene oxyethylamine, palmityl dioxybutylene oxypropylamine, decyl tetraoxy propylene oxypropylamine, and dodecyloxy propylene oxyethylamine; and wherein the organosilane comprises at least one selected from the group consisting of alkylsilanes, dialkylsilanes, polyalkylsilanes, organohalosilanes, organodihalosilanes, organopolyhalosilanes, oxalkylsilanes. aminosilanes, vinyl silanes, epoxy silanes, methacryl silanes, alkylsilanes, phenyl silanes, and halosilanes.

7. The binder of claim 5, wherein the oil component comprises vegetable oil and crude tall oil, and wherein the vegetable oil comprises at least one selected from the group consisting of corn oil, sunflower oil and jetropa oil, wherein the amine component comprises at least one selected from the group consisting of Triethanolamine (TEA), Diethanolamine (DEA) and Tetra-ethylenepentamine (TEPA), and wherein the organosilane comprises at least one selected from the group consisting of aminopropyltriethoxysilane, and epoxy silane.

8. The binder of claim 7, wherein the vegetable oil comprises corn oil, wherein the amine component comprises at least one selected from the group consisting of Triethanolamine (TEA) and Diethanolamine (DEA), and wherein the organosilane comprises aminopropyltriethoxysilane.

9. An asphalt article comprising asphalt, an amine component, an organosilane component, an oil component comprising at least one selected from the group consisting of vegetable oil and a crude tall oil.

10. The asphalt article of claim 9, wherein the article is at least one of paving, road surfaces, parking lots, runways, sports surfaces, playground surfaces, railway tracks, bridge decks, floorings, roofing materials, roofing coatings, sealants, cattle sprays, weatherproofed lumber, paint, lacquer, or substrate.

11. The article of claim 10, wherein the vegetable oil comprises at least one selected from the group consisting of canola oil, castor oil, coconut oil, corn oil, cottonseed oil, distilled tall oil, flax seed oil, jetropa oil, linseed oil, mustard, oil, olive oil, palm oil, peanut oil, rapeseed oil, safflower oil, sesame oil, sunflower oil, soybean oil, soy oil (biodiesel), castor oil, tung oil, tigernut oil, and linseed oil, wherein the amine component comprises at least one selected from the group consisting of Triethanolamine (TEA), Diethanolamine (DEA), Pentaethylenehaxamine (PEHA), Ethylenediamine (EDA), Triethylenetetramine (TETA), Tetra-ethylenepentamine (TEPA), octoxyethylamine, decoxyethylamine, dodecoxyethylamine, tetradecoxyethylamine, hexoxypropylamine, octoxypropylamine, nonoxypropylamine, decoxypropylamine, dodecoxypropylamine, tetradecoxypropylamine, palmityloxypropylamine, myristyloxypropylamine, hexyl dioxyethylene oxyethylamine, octyl trioxyethylene oxyethylamine, dodecyl tetraoxyethylene oxyethylamine, myristyl dioxyethylene oxypropylamine, octyl tetraoxyethylene oxypropylamine, dodecyl tetraoxyethylene oxypropylamine, octyl dioxypropylene oxypropylamine, decyl trioxypropylene oxyethylamine, tetradecyl tetraoxypropylene oxypropylamine, octyl oxypropylene oxypropylamine, palmityl tetraoxypropylene oxypropylamine, heptenyl oxypropylene oxypropylamine, decenyl dioxyethylene oxyethylamine, octenyl oxypropylene oxyethylamine, dodecenyl tetraoxypropylene oxypropylamine, octyloxybutylene oxbutylamine, decyl trioxybutylene oxybutylamine, dodecyl tetraoxybutylene oxyethylamine, palmityl dioxybutylene oxypropylamine, decyl tetraoxy propylene oxypropylamine, and dodecyloxy propylene oxyethylamine; and wherein the organosilane comprises at least one selected from the group consisting of alkylsilanes, dialkylsilanes, polyalkylsilanes, organohalosilanes, organodihalosilanes, organopolyhalosilanes, oxalkylsilanes. aminosilanes, vinyl silanes, epoxy silanes, methacryl silanes, alkylsilanes, phenyl silanes, and halosilanes.

12. The article of claim 11, wherein the oil component comprises vegetable oil and crude tall oil, and wherein the vegetable oil comprises at least one selected from the group consisting of corn oil, sunflower oil and jetropa oil, wherein the amine component comprises at least one selected from the group consisting of Triethanolamine (TEA), Diethanolamine (DEA) and Tetra-ethylenepentamine (TEPA), and wherein the organosilane comprises at least one selected from the group consisting of aminopropyltriethoxysilane, and epoxy silane.

13. The article of claim 12, wherein the vegetable oil comprises corn oil, wherein the amine component comprises at least one selected from the group consisting of Triethanolamine (TEA) and Diethanolamine (DEA), and wherein the organosilane comprises aminopropyltriethoxysilane.

14. A method of forming an asphalt mix comprising contacting asphalt binder, aggregate, an amine component, an organosilane component an oil component comprising at least one selected from the group consisting of vegetable oil and a crude tall oil.

15. The method of claim 14, wherein the vegetable oil comprises at least one selected from the group consisting of canola oil, castor oil, coconut oil, corn oil, cottonseed oil, distilled tall oil, flax seed oil, jetropa oil, linseed oil, mustard, oil, olive oil, palm oil, peanut oil, rapeseed oil, safflower oil, sesame oil, sunflower oil, soybean oil, soy oil (biodiesel), castor oil, tung oil, tigernut oil, and linseed oil, wherein the amine component comprises at least one selected from the group consisting of Triethanolamine (TEA), Diethanolamine (DEA), Pentaethylenehaxamine (PEHA), Ethylenediamine (EDA), Triethylenetetramine (TETA), Tetra-ethylenepentamine (TEPA), octoxyethylamine, decoxyethylamine, dodecoxyethylamine, tetradecoxyethylamine, hexoxypropylamine, octoxypropylamine, nonoxypropylamine, decoxypropylamine, dodecoxypropylamine, tetradecoxypropylamine, palmityloxypropylamine, myristyloxypropylamine, hexyl dioxyethylene oxyethylamine, octyl trioxyethylene oxyethylamine, dodecyl tetraoxyethylene oxyethylamine, myristyl dioxyethylene oxypropylamine, octyl tetraoxyethylene oxypropylamine, dodecyl tetraoxyethylene oxypropylamine, octyl dioxypropylene oxypropylamine, decyl trioxypropylene oxyethylamine, tetradecyl tetraoxypropylene oxypropylamine, octyl oxypropylene oxypropylamine, palmityl tetraoxypropylene oxypropylamine, heptenyl oxypropylene oxypropylamine, decenyl dioxyethylene oxyethylamine, octenyl oxypropylene oxyethylamine, dodecenyl tetraoxypropylene oxypropylamine, octyloxybutylene oxbutylamine, decyl trioxybutylene oxybutylamine, dodecyl tetraoxybutylene oxyethylamine, palmityl dioxybutylene oxypropylamine, decyl tetraoxy propylene oxypropylamine, and dodecyloxy propylene oxyethylamine; and wherein the organosilane comprises at least one selected from the group consisting of alkylsilanes, dialkylsilanes, polyalkylsilanes, organohalosilanes, organodihalosilanes, organopolyhalosilanes, oxalkylsilanes. aminosilanes, vinyl silanes, epoxy silanes, methacryl silanes, alkylsilanes, phenyl silanes, and halosilanes.

16. The method of claim 15, wherein the oil component comprises vegetable oil and crude tall oil, and wherein the vegetable oil comprises at least one selected from the group consisting of corn oil, sunflower oil and jetropa oil, wherein the amine component comprises at least one selected from the group consisting of Triethanolamine (TEA), Diethanolamine (DEA) and Tetra-ethylenepentamine (TEPA), and wherein the organosilane comprises at least one selected from the group consisting of aminopropyltriethoxysilane, and epoxy silane.

17. The method of claim 16, wherein the vegetable oil comprises corn oil, wherein the amine component comprises at least one selected from the group consisting of Triethanolamine (TEA) and Diethanolamine (DEA), and wherein the organosilane comprises aminopropyltriethoxysilane.

18. The method of claim 15, wherein the contacting is carried out at a temperature greater than 300° F. to form a hot mix asphalt.

19. The method of claim 16, wherein the contacting is carried out at a temperature in the range of about 220 to about 290° F. to form a warm mix asphalt.

20. The method of claim 17, wherein the contacting is carried out at a temperature in the range of about 120° F. at about 212° F. to form a half-warm mix asphalt.

21. The method of claim 16, wherein the contacting is carried out at a temperature in the range of about 45° F. at about 180° F., and in the presence of a solvent to form a cold-mix asphalt.

22. The method of claim 17, wherein the contacting is carried out at ambient temperature, and in the presence of a solvent to form a cold-mix asphalt.

23. A method of treating an asphalt article comprising contacting the article with a treatment composition comprising an amine component, an organosilane component, and an oil component comprising at least one selected from the group consisting of vegetable oil and a crude tall oil.

24. The method of claim 23, wherein the vegetable oil comprises at least one selected from the group consisting of canola oil, castor oil, coconut oil, corn oil, cottonseed oil, distilled tall oil, flax seed oil, jetropa oil, linseed oil, mustard, oil, olive oil, palm oil, peanut oil, rapeseed oil, safflower oil, sesame oil, sunflower oil, soybean oil, soy oil (biodiesel), castor oil, tung oil, tigernut oil, and linseed oil, wherein the amine component comprises at least one selected from the group consisting of Triethanolamine (TEA), Diethanolamine (DEA), Pentaethylenehaxamine (PEHA), Ethylenediamine (EDA), Triethylenetetramine (TETA), Tetra-ethylenepentamine (TEPA), octoxyethylamine, decoxyethylamine, dodecoxyethylamine, tetradecoxyethylamine, hexoxypropylamine, octoxypropylamine, nonoxypropylamine, decoxypropylamine, dodecoxypropylamine, tetradecoxypropylamine, palmityloxypropylamine, myristyloxypropylamine, hexyl dioxyethylene oxyethylamine, octyl trioxyethylene oxyethylamine, dodecyl tetraoxyethylene oxyethylamine, myristyl dioxyethylene oxypropylamine, octyl tetraoxyethylene oxypropylamine, dodecyl tetraoxyethylene oxypropylamine, octyl dioxypropylene oxypropylamine, decyl trioxypropylene oxyethylamine, tetradecyl tetraoxypropylene oxypropylamine, octyl oxypropylene oxypropylamine, palmityl tetraoxypropylene oxypropylamine, heptenyl oxypropylene oxypropylamine, decenyl dioxyethylene oxyethylamine, octenyl oxypropylene oxyethylamine, dodecenyl tetraoxypropylene oxypropylamine, octyloxybutylene oxbutylamine, decyl trioxybutylene oxybutylamine, dodecyl tetraoxybutylene oxyethylamine, palmityl dioxybutylene oxypropylamine, decyl tetraoxy propylene oxypropylamine, and dodecyloxy propylene oxyethylamine; and wherein the organosilane comprises at least one selected from the group consisting of alkylsilanes, dialkylsilanes, polyalkylsilanes, organohalosilanes, organodihalosilanes, organopolyhalosilanes, oxalkylsilanes. aminosilanes, vinyl silanes, epoxy silanes, methacryl silanes, alkylsilanes, phenyl silanes, and halosilanes.

25. The method of claim 24, wherein the oil component comprises vegetable oil and crude tall oil, and wherein the vegetable oil comprises at least one selected from the group consisting of corn oil, sunflower oil and jetropa oil, wherein the amine component comprises at least one selected from the group consisting of Triethanolamine (TEA), Diethanolamine (DEA) and Tetra-ethylenepentamine (TEPA), and wherein the organosilane comprises at least one selected from the group consisting of aminopropyltriethoxysilane, and epoxy silane.

26. The method of claim 25, wherein the vegetable oil comprises corn oil, wherein the amine component comprises at least one selected from the group consisting of Triethanolamine (TEA) and Diethanolamine (DEA), and wherein the organosilane comprises aminopropyltriethoxysilane.

27. The method of claim 25, wherein the contacting is carried out using water foaming.

28. The method of claim 26, wherein the contacting is carried out using a mist application.

29. A method of treating recycled asphalt comprising contacting the recycled asphalt with a treatment composition comprising an amine component, an organosilane component, and an oil component comprising at least one selected from the group consisting of vegetable oil and a crude tall oil.

30. The method of claim 29, wherein the vegetable oil comprises at least one selected from the group consisting of canola oil, castor oil, coconut oil, corn oil, cottonseed oil, distilled tall oil, flax seed oil, jetropa oil, linseed oil, mustard, oil, olive oil, palm oil, peanut oil, rapeseed oil, safflower oil, sesame oil, sunflower oil, soybean oil, soy oil (biodiesel), castor oil, tung oil, tigernut oil, and linseed oil, wherein the amine component comprises at least one selected from the group consisting of Triethanolamine (TEA), Diethanolamine (DEA), Pentaethylenehaxamine (PEHA), Ethylenediamine (EDA), Triethylenetetramine (TETA), Tetra-ethylenepentamine (TEPA), octoxyethylamine, decoxyethylamine, dodecoxyethylamine, tetradecoxyethylamine, hexoxypropylamine, octoxypropylamine, nonoxypropylamine, decoxypropylamine, dodecoxypropylamine, tetradecoxypropylamine, palmityloxypropylamine, myristyloxypropylamine, hexyl dioxyethylene oxyethylamine, octyl trioxyethylene oxyethylamine, dodecyl tetraoxyethylene oxyethylamine, myristyl dioxyethylene oxypropylamine, octyl tetraoxyethylene oxypropylamine, dodecyl tetraoxyethylene oxypropylamine, octyl dioxypropylene oxypropylamine, decyl trioxypropylene oxyethylamine, tetradecyl tetraoxypropylene oxypropylamine, octyl oxypropylene oxypropylamine, palmityl tetraoxypropylene oxypropylamine, heptenyl oxypropylene oxypropylamine, decenyl dioxyethylene oxyethylamine, octenyl oxypropylene oxyethylamine, dodecenyl tetraoxypropylene oxypropylamine, octyloxybutylene oxbutylamine, decyl trioxybutylene oxybutylamine, dodecyl tetraoxybutylene oxyethylamine, palmityl dioxybutylene oxypropylamine, decyl tetraoxy propylene oxypropylamine, and dodecyloxy propylene oxyethylamine; and wherein the organosilane comprises at least one selected from the group consisting of alkylsilanes, dialkylsilanes, polyalkylsilanes, organohalosilanes, organodihalosilanes, organopolyhalosilanes, oxalkylsilanes. aminosilanes, vinyl silanes, epoxy silanes, methacryl silanes, alkylsilanes, phenyl silanes, and halosilanes.

31. The method of claim 30, wherein the oil component comprises vegetable oil and crude tall oil, and wherein the vegetable oil comprises at least one selected from the group consisting of corn oil, sunflower oil and jetropa oil, wherein the amine component comprises at least one selected from the group consisting of Triethanolamine (TEA), Diethanolamine (DEA) and Tetra-ethylenepentamine (TEPA), and wherein the organosilane comprises at least one selected from the group consisting of aminopropyltriethoxysilane, and epoxy silane.

32. The method of claim 31, wherein the vegetable oil comprises corn oil, wherein the amine component comprises at least one selected from the group consisting of Triethanolamine (TEA) and Diethanolamine (DEA), and wherein the organosilane comprises aminopropyltriethoxysilane.

33. A method of forming a foam comprising
Forming an asphalt mixture comprising asphalt binder, an amine component, an organosilane component, and an oil component comprising at least one selected from the group consisting of vegetable oil and a crude tall oil;
Injecting water into the asphalt mixture while the asphalt mixture is at a temperature sufficient to convert at least a portion of the water into steam;
Allowing at least a portion of the water to convert into steam and for at least a portion of the asphalt mixture to foam.

34. The method of claim 33, wherein the vegetable oil comprises at least one selected from the group consisting of canola oil, castor oil, coconut oil, corn oil, cottonseed oil, distilled tall oil, flax seed oil, jetropa oil, linseed oil, mustard, oil, olive oil, palm oil, peanut oil, rapeseed oil, safflower oil, sesame oil, sunflower oil, soybean oil, soy oil (biodiesel), castor oil, tung oil, tigernut oil, and linseed oil, wherein the amine component comprises at least one selected from the group consisting of Triethanolamine (TEA), Diethanolamine (DEA), Pentaethylenehaxamine (PEHA), Ethylenediamine (EDA), Triethylenetetramine (TETA), Tetra-ethylenepentamine (TEPA), octoxyethylamine, decoxyethylamine, dodecoxyethylamine, tetradecoxyethylamine, hexoxypropylamine, octoxypropylamine, nonoxypropylamine, decoxypropylamine, dodecoxypropylamine, tetradecoxypropylamine, palmityloxypropylamine, myristyloxypropylamine, hexyl dioxyethylene oxyethylamine, octyl trioxyethylene oxyethylamine, dodecyl tetraoxyethylene oxyethylamine, myristyl dioxyethylene oxypropylamine, octyl tetraoxyethylene oxypropylamine, dodecyl tetraoxyethylene oxypropylamine, octyl dioxypropylene oxypropylamine, decyl trioxypropylene oxyethylamine, tetradecyl tetraoxypropylene oxypropylamine, octyl oxypropylene oxypropylamine, palmityl tetraoxypropylene oxypropylamine, heptenyl oxypropylene oxypropylamine, decenyl dioxyethylene oxyethylamine, octenyl oxypropylene oxyethylamine, dodecenyl tetraoxypropylene oxypropylamine, octyloxybutylene oxbutylamine, decyl trioxybutylene oxybutylamine, dodecyl tetraoxybutylene oxyethylamine, palmityl dioxybutylene oxypropylamine, decyl tetraoxy propylene oxypropylamine, and dodecyloxy propylene oxyethylamine; and wherein the organosilane comprises at least one selected from the group consisting of alkylsilanes, dialkylsilanes, polyalkylsilanes, organohalosilanes, organodihalosilanes, organopolyhalosilanes, oxalkylsilanes. aminosilanes, vinyl silanes, epoxy silanes, methacryl silanes, alkylsilanes, phenyl silanes, and halosilanes.

35. The method of claim 34, wherein oil component comprises vegetable oil and crude tall oil, and wherein the vegetable oil comprises at least one selected from the group consisting of corn oil, sunflower oil and jetropa oil, wherein the amine component comprises at least one selected from the group consisting of Triethanolamine (TEA), Diethanolamine (DEA) and Tetra-ethylenepentamine (TEPA), and wherein the organosilane comprises at least one selected from the group consisting of aminopropyltriethoxysilane, and epoxy silane.

36. The method of claim 35, wherein the vegetable oil comprises corn oil, wherein the amine component comprises at least one selected from the group consisting of Triethanolamine (TEA) and Diethanolamine (DEA), and wherein the organosilane comprises aminopropyltriethoxysilane.
